(19) United States
(12) Patent Application Publication
(10) Pub. No.: US 2009/0271645 A1
(43) Pub. Date: Oct. 29, 2009

(54) Management apparatus, storage apparatus and information processing system

(75) Inventor: Hajime Mori, Yokohama (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/222,001

(22) Filed: Jul. 31, 2008

(30) Foreign Application Priority Data
Apr. 24, 2008 (JP) 2008-114189

(51) Int. Cl. G06F 1/32

(52) U.S. Cl. 713/320

(57) ABSTRACT

Proposed are a management apparatus, a storage apparatus, and an information processing system capable of improving the storage apparatus performance and power saving efficiency. This management apparatus connected to a storage apparatus arranged in a power supply range set with a threshold value of power supplied externally includes a control unit configured to control, based on electric energy used for operating one or more conducting parts that are energized through supply of external power and subject to power saving control and the power threshold value, the power supplied to the one or more conducting parts in conducting part units.

### CROSS-REFERENCES

This application relates to and claims priority from Japanese Patent Application No. 2008-114189, filed on Apr. 24, 2008, the entire disclosure of which is incorporated herein by reference.

### BACKGROUND

The present invention generally relates to a management apparatus, a storage apparatus, and an information processing system, and in particular relates to technology for controlling the power consumed by a storage apparatus.

Storage apparatuses are managed in RAID (Redundant Array of Inexpensive Disks) format, and include a plurality of disk devices arranged in an array and a control unit for controlling such plurality of disk devices. A storage apparatus is connected to a host computer (hereinafter also referred to as a “host”) such as a server, and provides a logical storage area (hereinafter also referred to as a “logical volume”) made redundant based on RAID configuration.

Meanwhile, in recent years, the amount of data to be managed by companies is increasing daily. In connection with this, storage apparatuses are becoming large scale and power consumption is increasing. Moreover, the number of electronic devices including a storage apparatus that are installed in data centers is of an increasing trend, and the power consumption of the overall data center is also increasing. Here, an electronic device shall mean a device that operates by being energized.

Among the various types of electronic devices that are installed in data centers, there are electronic devices that need to be switched from a normal operating status to a power saving status, and electronic devices that control the operation of conducting parts that require the reduction of power consumption in comparison to normal operation due to the suspension of electrical conduction or the like.

For instance, the specification of US Patent Application Publication No. 2005/0210304 (“Patent Document 1”) discloses technology for restricting the power consumption of a storage apparatus included in an electronic device. Patent Document 1 discloses technology of estimating the power consumption after the storage apparatus is started upon starting a disk device, determining whether the estimated power consumption exceeds a predetermined threshold value, and thereby controlling the start or stop of the disk device. According to Patent Document 1, power consumption of the storage apparatus can be reduced by restricting the power consumption of the storage apparatus to be less than a predetermined threshold value as a result of controlling the start and stop of the disk device.

### SUMMARY

With conventional technology, an electronic device is operated without consideration to the range of power supplied from an external power source and the physical arrangement of electronic devices including a storage apparatus.

Here, as a specific example for explaining the relationship of the physical arrangement of chassises of the storage apparatus and the supply capability, the ensuing explanation refers to the installation of electronic devices and the supply of power in a collocation service (also referred to as a facility service) in data centers. The following specific example is merely an exemplification, and is not intended to limit the present invention.

A collocation service is a service where a data center service provider provides space (hereinafter referred to as the “rental space”), air conditioning and power for installing electronic devices to be brought into the data center by customers of the data center service (hereinafter referred to as the “customers”).

With the collocation service or the like, the data center service provider and the customer decide on the rental space and the upper limit of the power to be supplied. Here, there are cases where the boundary of the range that the electronic devices with the agreed-upon upper limit of power supply can be installed (hereinafter also referred to as the “power supply range”) and the boundary of the rental space do not coincide. Specifically, if the upper limit of power supply is decided in one-rack units as the power supply range and two racks worth of space is rented to the customer, the rental space of the customer will have two power supply ranges.

Generally speaking, the power supply range and the upper limit of power supply will differ depending on the subject matter of the billing contract executed between the data center service provide and the customer. Nevertheless, the power supply range and the upper limit of power supply are subject to restrictions based on the installable parts of data center equipment such as the data center's distribution board, UPS (Uninterruptible Power Supply), transformation unit, and wattmeter power, and the subject matter of the electricity contract with the power company to supply power to the data center. Thus, there is a limit in the power supply range and the upper limit of power supply and, when changing the power to be higher than the power that was set during the design-time of the data center, it is necessary to change the data center equipment, and this will entail additional costs. Thus, in most cases, it is not possible to arbitrarily change the supply capability in accordance with the power consumption of electronic devices installed in the data center. Incidentally, if the customer uses power exceeding the upper limit of power supply under the contract with the power company, there are cases where penalty charges for excessive use are billed to the customer.

In other words, when installing electronic devices including a storage apparatus in a data center, there are cases where the space for installing the devices and the power supply range, which is subject to restriction due to the data center equipment such as the distribution board, do not coincide. If the power supply range does not coincide with the space for installing the devices, depending on the physical location of the installed electronic devices, for instance, such electronic devices may exist across a plurality of power supply ranges or share the same power supply range with other electronic devices. The foregoing was the explanation on the relationship of the physical arrangement of chassises of the storage apparatus and the supply capability.

In connection with the above, there are cases where one or more storage apparatuses are installed across a power supply range or a plurality of storage apparatuses are installed in a single power supply range without consideration to the relationship of the physical arrangement of the chassises of the storage apparatus and the range of the power that is supplied externally. Since a storage apparatus is operated and controlled with the maximum power consumed by the storage apparatus (hereinafter referred to as the “maximum power control”), even if the power consumption of the storage apparatus is less than the upper limit of power supply, the start-up of a disk device that needs to be started for sending a data reply to the host is restricted, and the operational control cannot be implemented efficiently. Consequently, there are problems in that the storage apparatus performance will deteriorate and the power usage efficiency will also deteriorate.

As described above, with conventional technology that gives no consideration to the relationship of the physical arrangement of chassises of the storage apparatus and the power supply range, there are cases where the start-up of the power saving control unit that needs to be operated is subject to restriction even when the power consumed by the electronic devices including a storage apparatus has surplus power (hereinafter referred to as the “surplus power”) up to the upper limit of power supply. Consequently, there are cases where the power usage efficiency of the electronic device will deteriorate, and the electronic device is unable to sufficiently exhibit its performance. Further, the apparatus configuration of electronic devices giving consideration to the power supply range and the comprehension of the utilized power are complicated, they cause increased management costs.

Thus, an object of the present invention is to propose a management apparatus, a storage apparatus, and an information processing system capable of improving the storage apparatus performance and power saving efficiency by performing control that gives consideration to the range of power that is supplied from an external power source and the physical arrangement of electronic devices including a storage apparatus.

In order to achieve the foregoing object, the management apparatus of the present invention connected to a storage apparatus arranged in a power supply range set with a threshold value of power supplied externally includes a control unit for controlling, based on electric energy used for operating one or more conducting parts that are energized through supply of external power and subject to power saving control and the power threshold value, the power supplied to the one or more conducting parts in conducting part units.

Consequently, it is possible to perform control that gives consideration to the range of power that is supplied from an external power source and the physical arrangement of electronic devices including a storage apparatus.

The present invention additionally provides a storage apparatus connected to a management apparatus and arranged in a power supply range set with a threshold value of power supplied externally. This storage apparatus comprises one or more conducting parts that are energized through supply of external power and subject to power saving control, and a control unit configured to control the power supplied to the one or more conducting parts in conducting part units based on the electric energy used for operating the one or more conducting parts and the power threshold value according to a command from the management apparatus.

Consequently, it is possible to perform control that gives consideration to the range of power that is supplied from an external power source and the physical arrangement of electronic devices including a storage apparatus.

The present invention further provides a system comprising a management apparatus and a storage apparatus connected to the management apparatus. In this system, the storage apparatus is arranged in a power supply range set with a threshold value of power supplied externally, and includes one or more conducting parts that are energized through supply of external power and subject to power saving control. Moreover, the management apparatus includes a control unit configured to control, based on electric energy used for operating one or more conducting parts and the power threshold value, the power supplied to the one or more conducting parts in conducting part units.

Consequently, it is possible to perform control that gives consideration to the range of power that is supplied from an external power source and the physical arrangement of electronic devices including a storage apparatus.

According to the present invention, it is possible to improve the storage apparatus performance and power saving efficiency by performing control that gives consideration to the range of power that is supplied from an external power source and the physical arrangement of electronic devices including a storage apparatus.

### DESCRIPTION OF DRAWINGS

FIG. 1 is a diagram showing an example of a schematic configuration of a system according to the first embodiment;

FIG. 2 is a diagram showing an example of a schematic configuration of a storage apparatus according to the first embodiment;

FIG. 3 is a diagram showing an example of a schematic configuration of a physical arrangement of the chassises of the storage apparatus and the power supply range according to the first embodiment;

FIG. 4 is a diagram showing an example of an apparatus configuration information table according to the first embodiment;

FIG. 5 is a diagram showing an example of a power saving management table according to the first embodiment;

FIG. 6 is a diagram showing an example of a steady power management table according to the first embodiment;

FIG. 7 is a diagram showing an example of a system power management table according to the first embodiment;

FIG. 8 is a flowchart showing the setting processing of the system power management table according to the first embodiment;

FIG. 9 is a flowchart showing the update processing of the system power management table to be executed on the side of the storage apparatus in the first embodiment;

FIG. 10 is a flowchart showing the update processing of the system power management table to be executed on the side of the management server in the first embodiment;

FIG. 11 is a flowchart showing the power saving control processing according to the first embodiment;

FIG. 12 is a flowchart showing the start-up request generation processing according to the first embodiment;

FIG. 13 is a flowchart showing the start-up determination processing according to the first embodiment;

FIG. 14 is a flowchart showing the stop processing according to the first embodiment;

FIG. 15 is a flowchart showing the start-up processing according to the first embodiment;

FIG. 16 is a flowchart showing the change processing of the supply capability upper limit in the first embodiment;

FIG. 17 is a diagram showing an example of the memory contents according to the second embodiment;

FIG. 18 is a diagram showing an example of a system power management information history table according to the second embodiment;

FIG. 19 is a diagram of a management screen showing the relationship of the system configuration and power usage in the second embodiment; and

FIG. 20 is a diagram of a management screen showing the relationship of the transition of power consumption and the output of history in the second embodiment.

### DETAILED DESCRIPTION

The embodiments of the present invention described below are not intended to limit the scope of the invention claimed herein, and all subject matter that is disclosed herein is not necessarily required as the means for solving the problems of the present invention.

As a preferred embodiment for working the present invention, this embodiment controls the operation of a storage apparatus based on the relationship of the physical arrangement of chassises of the storage apparatus and the supply capability, and the supply capability usage in power saving control units (a unit where control for reducing power consumption is possible in comparison to the power consumption during normal operation) in the maximum power control of the maximum power consumed by the storage apparatus arranged in a power supply range set with a threshold value of power supplied externally.

This embodiment reduces management costs by outputting a management screen based on the physical arrangement of electronic devices including a storage apparatus and the power supply range, and additionally reduces the power consumption while starting a power saving control unit that needs to be operated while maintaining the performance thereof by efficiently controlling the maximum power control of electronic devices within the upper limit (threshold value) of the supply capability and thereby optimizing the power usage.

### (1) First Embodiment

### (1-1) System Configuration of First Embodiment

The first embodiment is now explained taking a system configuration as an example with reference to the attached drawings.

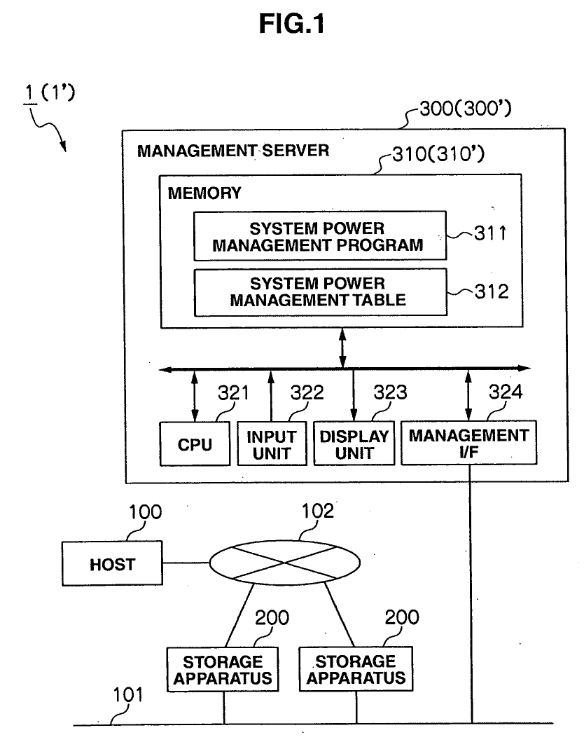

FIG. 1 is a diagram showing the outline of the system configuration according to the first embodiment.

An information processing system 1 of this embodiment includes a host 100, a storage apparatus 200, and a management server 300. Although the information processing system 1 of this embodiment has one host 100, two storage apparatuses 200 and one management server 300, the information processing system 1 may include one or more of these components, respectively.

The host 100, the storage apparatus 200, and the management server 300 are connected to a management network 101 such as a LAN (Local Area Network). The host 100 is connected to the storage apparatus 200 via a data network 102 such as a SAN (Storage Area Network). A communication protocol such as a fibre channel or iSCSI (Internet Small Computer System Interface) is used as the SAN.

The storage apparatus 200 is connected to the host 100 via the data network 102, and provides a storage area to the host 100. The storage apparatus 200 is connected to the management server 300 via the management network 101. The additional configuration of the storage apparatus 200 will be described later.

The host 100 is a general-purpose computer and, although omitted in FIG. 1, comprises a CPU, a memory, a SAN interface for connecting to the data network 102, and so on. The host 100 executes applications such as a business program, and writes the processing result in the storage apparatus 200 via the data network 102, or uses the information resources stored in the storage apparatus 200.

The management server is a general-purpose computer, and comprises a CPU 321, a memory 310, an input unit 322 such as a keyboard and a mouse, a display unit 323 such as a monitor display, a management interface 324 (indicated as management I/F in the drawings), and so on. The memory 310 stores a system power management program 311 and a system power management table 312. The operation of the system power management program 311 and the system power management table 312 will be described later.

The system power management program 311 and the system power management table 312 may also be stored in the memory of the host 100. In this case, the host 100 must be connected to the storage apparatus 200 via the management network 101. Incidentally, the management server 300 may also be loaded in the storage apparatus 200 as a management unit of the storage apparatus 200.

The storage apparatus 200 is an apparatus that is configured from a plurality of chassises. One chassis among the respective chassises is a basic chassis (first chassis) which enables communication with a host system (for instance the host 100) via the data network 102, communication with the management server 300 via the management network 101, and communication that governs the control of the overall storage apparatus 200 that controls the operation of the other chassises. The chassises other than the basic chassis are respectively an expanded chassis (second chassis) comprising a plurality of storage devices (for instance disk devices), and are connected to the basic chassis for sending signals and data.

The basic chassis accesses the disk devices in the expanded chassis according to a command issued from the host 100 for reading and writing data. There are cases where the basic chassis includes a plurality of storage devices.

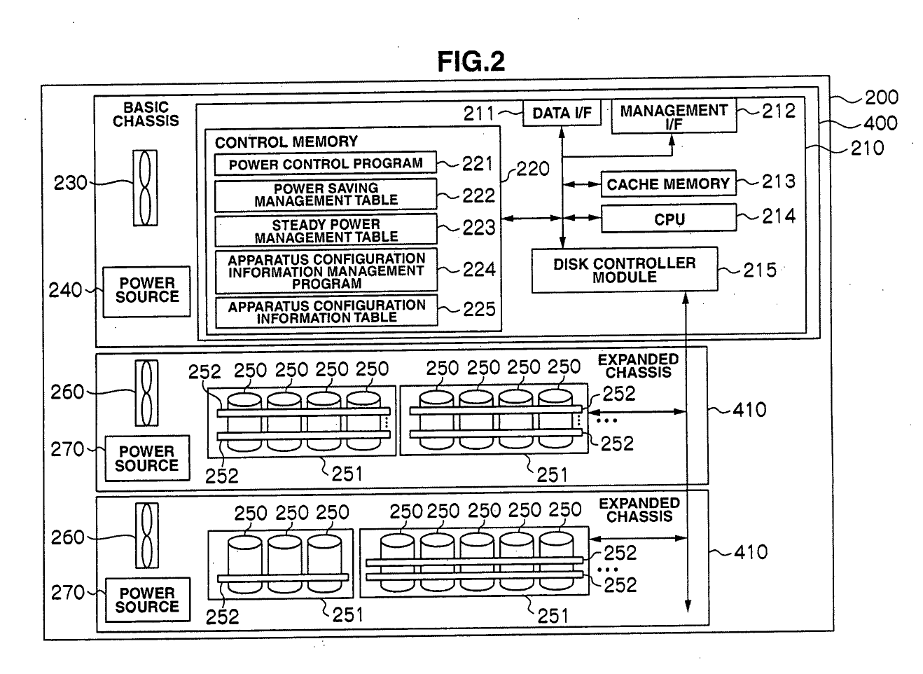

FIG. 2 is a schematic diagram of a configuration example of the storage apparatus 200. FIG. 2 shows the basic chassis 400 and the expanded chassises 410. Although FIG. 2 shows a configuration example of a storage apparatus including one basic chassis and two expanded chassises, a plurality of expanded chassises may be provided in relation to one basic chassis. In addition, a plurality of basic chassises may be provided to separately possess the functions of the first chassis.

The basic chassis 400 is configured mainly from a storage controller 210, a power source 240, and a fan 230. As described above, the basic chassis may also include one or more disk devices.

The storage controller 210 is a control module for executing the various types of control processing of the storage apparatus 200. The storage controller 210 is configured mainly from a data interface (indicated as data I/F in the drawings) 211, a disk control module 215, a cache memory 213, a CPU 214, control information memory 220, and a management interface (indicated as management I/F in the drawings) 212 as an interface to the management network 101.

The data interface 211 is an interface for connecting to the host 100 via the data network 101 and inputting and outputting data. The disk control module 215 is a control module for controlling the disk devices 250 of the expanded chassis 410 to be connected.

The cache memory 213 temporarily stores data to be written into the disk device 250 or data that was read from the disk device 250.

The control memory 220 stores management data and the like of the storage apparatus 200. The operation of the power control program 221, the operation of the apparatus configuration information management program 224, and power saving management table 222, the steady power management table 223 and the apparatus configuration information table 225 stored in the control memory 220 will be described later.

The cache memory 213 and the control memory 220 may be a volatile memory or a non-volatile memory (for instance a flash memory). The storage controller 210 may also retain a plurality of cache memories 213 and control memories 220 to achieve a redundant configuration.

The expanded chassis 410 includes one or more disk devices 250, a fan 260, a power source 270, and a control platform (not shown). The expanded chassis 410 is connected to the disk control module 215 of the basic chassis 400, and transmits signals and data between the disk control module 215 and the disk devices 250 of the expanded chassis 410. In FIG. 2, although the connection between the basic chassis 400 and the expanded chassises 410 is of a cascade connection, this may also be a star connection where a switch is arranged between the basic chassis 400 and a plurality of expanded chassises 410, and such plurality of expanded chassises are connected around the basic chassis 400 via the switch. The connection may also be of other connection modes. The control platform (not shown) of the expanded chassis 410 communicates various types of information (such as the operating status and failure information of the respective disk devices 250) of the expanded chassis 410 with the storage controller 210 of the basic chassis 400. When engaging in this kind of communication, an interconnection line that is different from the interconnection line that transmits signals and data of the disk device 250 may also be used.

The power source 240 of the basic chassis 400 and the power source 270 of the expanded chassis 410 convert the AC power source or the DC power source input from an external power source (not shown) into a DC power source having a prescribed voltage; and supply this to the respective components (such as the storage controller 210, disk device 250, and fan 230) in the chassis. The power sources 240, 270 are able to output a plurality of types of voltages.

The external power source is not limited to an AC power source, and may also be a DC power source. The power sources 240, 270 may also be configured to stop the conducting of electricity (energization) to the respective components in the chassis according to a command from the storage controller 210 of the basic chassis 400. The stop command for stopping the conducting of electricity may also be issued by the management server 300 or the control platform of the expanded chassis 410.

The fan 230 of the basic chassis 400 and the fan 260 of the expanded chassis 410 are for cooling the chassis by introducing cooling air therein. The expanded chassis 410 is able to control the start and stop of operation of the fans 230, 260 as well as the rotating speed thereof according to a command from the storage controller 210 of the basic chassis 400.

The control for operating the fans 230, 260 may also be based on a command from the management server 300, the expanded chassis 410, or the fans 230, 260 themselves. Although fans were described as the cooling mechanism, other cooling mechanisms may also be used. In such a case, for instance, the expanded chassis 410 will control the operation of a cooling water circulation pump or a heat exchanger.

The one or more disk devices 250 of the expanded chassis 410 are defined as a group (hereinafter also referred to as a “RAID group”) having a redundant configuration such as a RAID configuration. All storage areas or a partial storage area of the one or more disk devices 250 configuring one RAID group is defined as a logical storage area (hereinafter referred to as a “logical volume”) 252. The logical volume 252 is provided to the host 100 as a physical or a logical storage apparatus. Thereby, even if a disk device 250 contained in the same RAID group malfunctions, it is possible to prevent the content of data stored in the logical volume 252 from being lost.

In this embodiment, the disk devices 250 are started or stopped in RAID group units pursuant to the control of the storage controller 210 of the basic chassis 400.

The start-up in RAID group units refers to the transition of the one or more disk devices 250 configuring a RAID group from an arbitrary status to a status capable of processing read/write requests. Here, the status capable of processing read/write requests is a status, for example, where the power source of the control unit of the disk device 250 is turned ON, and the storage medium (for instance a disk (also referred to as a “platter”)) of the disk device 250 rotates.

The stoppage in RAID groups refers to the transition of the one or more disk devices 250 configuring a RAID group from an operating status to a status where the power consumption is lower in comparison to the operating disk device. Here, a stopped status refers to a status where the rotation of the platter is stopped, a status where the control unit of the disk device is turned OFF or in a power saving mode, or a status where the conducting of electricity is stopped and the power source is turned OFF.

The disk device 250 may also start or stop the disk device 250 or set the disk device 250 to a power saving mode based on the control of the control platform of the expanded chassis 410 or the control of the disk device 250 itself.

Although not shown, the storage controller 210, the fans 230, 260, the power sources 240, 270, and the control platform may be duplexed to realize a redundant configuration in order to improve reliability.

Generally speaking, in a data center or the like, the basic chassis 400 and the expanded chassises 410 of the storage apparatus 200 are arranged in a rack and, with large scale storage apparatuses 200, there are cases where the chassises 400, 410 of the storage apparatus 200 are separately arranged in a plurality of racks. For instance, when the basic chassis 400 is arranged in the first rack, and the expanded chassis 410 to be connected to this basic chassis 400 is arranged in a separate second rack, by connecting the first rack and the second rack with a cable or the like, the basic chassis 400 will be able to transmit signals and data to and from the expanded chassis 410 arranged in a different rack.

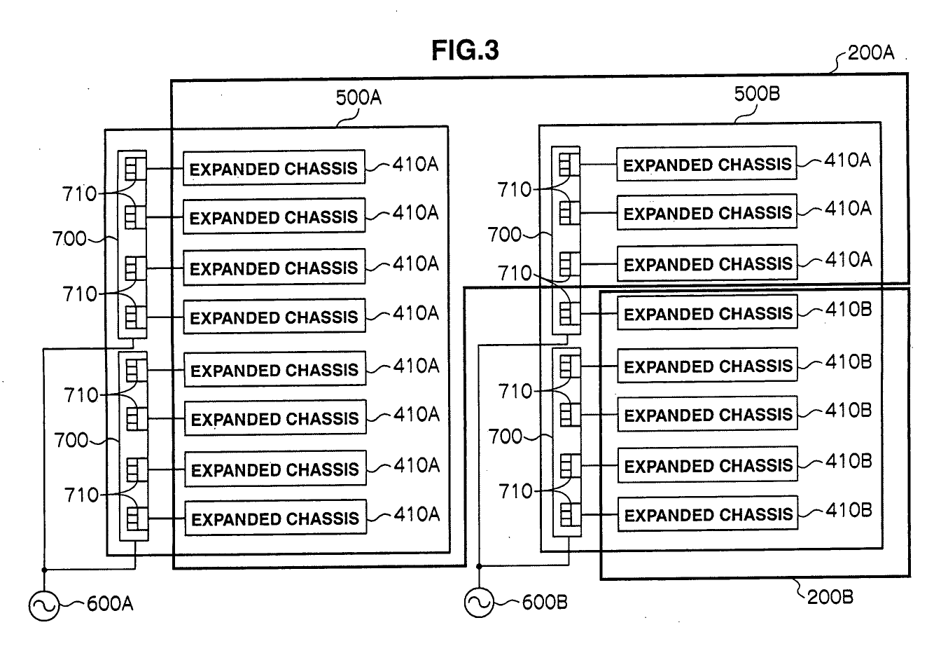

FIG. 3 is an example of a schematic diagram of the physical arrangement of the chassises 400, 410 of the storage apparatus 200 and the external supply capability according to the present embodiment.

FIG. 3 shows an example where a storage apparatus 200A configured from a basic chassis 400A and a plurality of expanded chassises 410A connected to the basic chassis 400A, and a storage apparatus 200B configured from a basic chassis 400B and a plurality of expanded chassises 410B connected to the basic chassis 400B are arranged in two racks 500A, 500B. Incidentally, the interconnection line to be used for transmitting signals and data between the basic chassis 400 and the expanded chassises 410 is not shown. Moreover, the suffix of A, B will not be added unless the components need to be differentiated.

The basic chassis 400A of the storage apparatus 200A, and certain expanded chassises 410A among the plurality of expanded chassises 410A of the storage apparatus 200A are arranged in the rack 500A. The remaining expanded chassises 410A among the plurality of expanded chassises 410A of the storage apparatus 200A are arranged in the rack 500B.

The basic chassis 400B and the expanded chassises 410B of the storage apparatus 200B are arranged in the rack 500B. An external power source 600A inputs the AC power source into the rack 500A, and an external power source 600B inputs the AC power source into the rack 500B.

The power is distributed to the respective chassises 400, 410 via the connector 710 with a PDU (Power Distribution Unit) 700 in the respective racks 500. The upper limit of the power to be supplied from the external power source 600A and the external power source 600B is decided individually for each external power source 600A, 600B. In this embodiment, the rack 500A and the rack 500B respectively belong to different power supply ranges.

Here, a power supply range refers to the range defined with an upper limit (threshold value) among the power to be supplied from one external power source and, in this embodiment, the range of power to be supplied from one external power source is set in one rack. Nevertheless, the setting of the power supply range is not limited to the foregoing example. This is because there are cases where two or more racks are arranged in one power supply range. In this case, the two or more racks become one power supply range.

Each external power source 600A, 600B may be sectioned according to the power source equipment distributed with the distribution panel of the data center, or logically sectioned by differentiating the upper limits of the supply capability even though they are physically the same power source. The external power sources 600A, 600B, as described above, may be an AC power source or a DC power source.

In the rack 500, there is a rack that is dedicated to housing the storage apparatus 200. The rack illustrated in FIG. 3 shows an example of using a dedicated rack for housing the storage apparatus 200, but it is not necessary to use a dedicated rack.

Specifically, the respective racks 500 may house, in addition to the storage apparatus 200, a computer such as the host 100, the PDU 700, a UPS (Uninterruptible Power Supply), a connection switch of electronic devices, a cooling device of electronic devices, a router, a management client, a tape drive, as well as any and all other electronic devices that are installed in a data center. In this case, if these electronic devices are supplied with power from the same external power source 600 as the storage apparatus 200, these electronic devices are connected to the management server 300 via the management network 101. The management server 300 is notified of the individual identifier, the operating status and the used power consumption given to each of the electronic devices from such electronic devices, and stores and manages such information in the system power management table 312 described later. Otherwise, a user may directly input information concerning the identifier, the operating status, and the used power consumption in the management server 300.

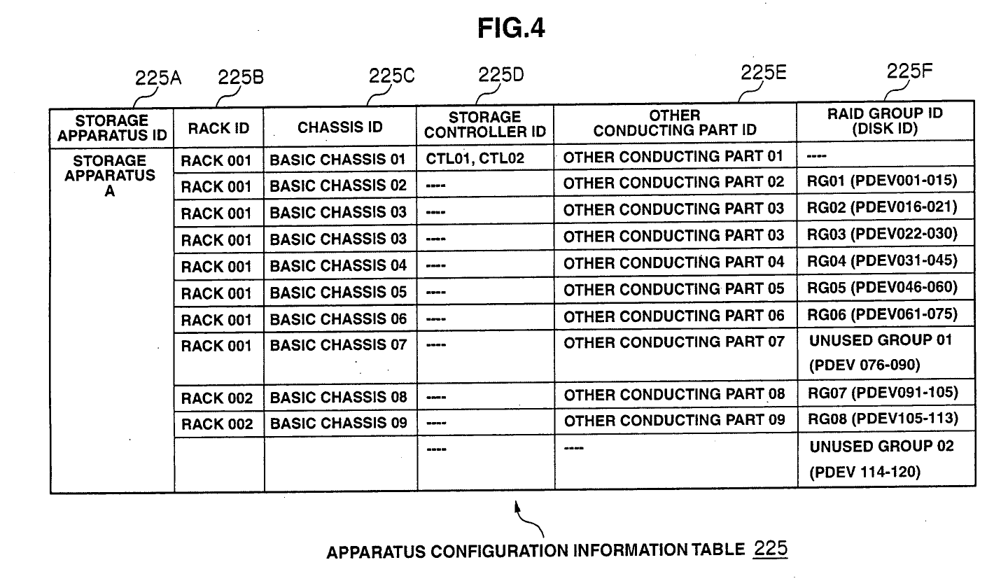

FIG. 4 is a diagram showing an example of the apparatus configuration information table 225 stored in the control memory 220 of the basic chassis 400 of the storage apparatus 200.

The apparatus configuration information table 225 is used by the apparatus configuration information management program 224 to be executed by the CPU 214 of the basic chassis 400 of the storage apparatus 200.

The apparatus configuration information table 225 is a table retained in each storage apparatus 200, and stores the physical and logical configuration information of the storage apparatus 200. The apparatus configuration information table 225 is configured from a “storage apparatus ID” column 225A, a “rack ID” column 225B, a “chassis ID” column 225C, a “storage controller ID” column 225D, an “other conducting part ID” column 225E, and a “RAID group ID (disk ID)” column 225F.

The “storage apparatus ID” column 225A stores the unique identifier of the storage apparatus 200.

The “rack ID” column 225B stores the unique identifier of the rack 500 to store the basic chassis 400 or the expanded chassis 410 of the storage apparatus 200.

The “chassis ID” column 225C stores the unique identifier allocated to the basic chassis 400 and the expanded chassis 410 belonging to the storage apparatus 200.

The “storage controller ID” column 225D stores the unique identifier of the storage controller 210 in the basic chassis 400 of the storage apparatus 200.

The “other conducting part ID” column 225E stores the unique identifier of other conducting parts set for each chassis 400, 410 and which are parts (excluding the storage controller 210 and the power saving control unit (RAID group units and disk device units in this embodiment)) that are energized and operate by being supplied with the power source 600 among the constituent parts of the storage apparatus 200. As the other conducting parts, there are the constituent parts (excluding the storage controller 210) such as the fans 230, 260, the power sources 240, 270, a battery (not shown), and a control platform (not shown) of the expanded chassis that are energized and operate by being supplied with the power source 600.

The “RAID group ID (disk ID)” column 225F stores the unique identifier of the RAID group 251 of the storage apparatus 200, and the unique identifier of one or more disk devices 250 belonging to that RAID group 251.

Although not shown in FIG. 2, there are also disk devices that do not belong to a RAID group (hereinafter referred to as the “unused disk devices”). Since an unused disk device is not recognized by the host 100, it is a disk device with no host access. The unused disk devices are compiled as an “unused group” for each chassis and managed by being given a unique identifier. The “RAID group ID (disk ID)” column 225F stores the unique identifier of the unused group and the unique identifier of the affiliated disk device.

Moreover, although not shown in FIG. 2, among the unused disk devices, there are disk devices (spare disks) used as a backup for saving data from a failed disk device 250 when a failure occurs in such disk device 250 belonging to the RAID group 251. In this embodiment, the spare disks are also included in the unused group. The identifier to be assigned to each spare disk may also be stored in the “RAID group ID (disk ID)” column 225F.

Although the “other conducting part ID” column 225E was provided in this embodiment, item columns for individually registering the configuration of the storage apparatus 200 may be increased for storing information of the logical volume 252, the fans 230, 260, the power sources 240, 270, a battery (not shown), and a control platform (not shown) of the expanded chassis. Without limitation to the above, any element configuring the storage apparatus 200 may be used.

FIG. 5 is a diagram showing an example of the power saving management table 222 stored in the control memory 220 of the basic chassis 400 of the storage apparatus 200.

The power saving management table 222 is used by the power control program 221 to be executed by the CPU 214 in the basic chassis 400 of the storage apparatus 200.

The power saving management table 222 is a table for managing the operating status and the power consumption of the power saving control unit of the storage apparatus 200. The power saving management table 222 is configured from a “power saving control unit ID” column 222A, an “operating status information” column 222B, a “power consumption value” column 222C, a “power consumption value during power saving” column 222D, and a “start-up power value” column 222E.

The “power saving control unit ID” column 222A stores the unique identifier (for instance the unique identifier of the RAID group 251) of the power saving control unit of the storage apparatus 200.

Here, a power saving control unit is a unit in which power consumption can be reduced in comparison to the power consumption during normal operation. As the control for reducing the power consumption there is, for instance, the control for suppressing the rotating speed of the disk device. Moreover, a unit in which the power consumption can be reduced refers to the conducting part that can be switched from a normal operating status to a power saving status, and a conducting part capable of reducing the power consumption in comparison to normal operation due to the stoppage of the conducting of electricity. In this embodiment, although the power saving control unit is a RAID group unit, it will suffice so as long as it is a conducting part unit (conducting part unit that can be switched from a normal operating status to a power saving status, or a conducting part unit in which the power consumption can be reduced in comparison to normal operation due to the stoppage of the conducting of electricity). In addition, power saving includes, in addition to power that is lower than the power required for normal operation, zero power due to the stoppage of the conducting of electricity.

The “operating status information” column 222B stores the operating status for each piece of information stored in the “power saving control unit ID” column 222A. For example, information of “Operating” is stored in the “operating status information” column 222B if the RAID group “01” is operating, and the information of “Stopped” is stored if the RAID group “02” is stopped.

The “power consumption value” column 222C stores the power consumption during normal operation for each piece of information stored in the “power saving control unit ID” column 222A.

The “power consumption value during power saving” column 222D stores the value of power consumption during a power saving status (including a stopped status) for each piece of information stored in the “power saving control unit ID” column 222A. For example, in FIG. 5, the RAID group “01” is set so that it can be controlled at “300 W” during normal operation and at “0 W” during power saving.

The “start-up power value” column 222E stores the peak power during the start-up for each piece of information stored in the “power saving control unit ID” column 222A.

If the power saving control unit includes a plurality of power saving statuses, the “power consumption value during power saving” column 222D may individually store information for each power saving status.

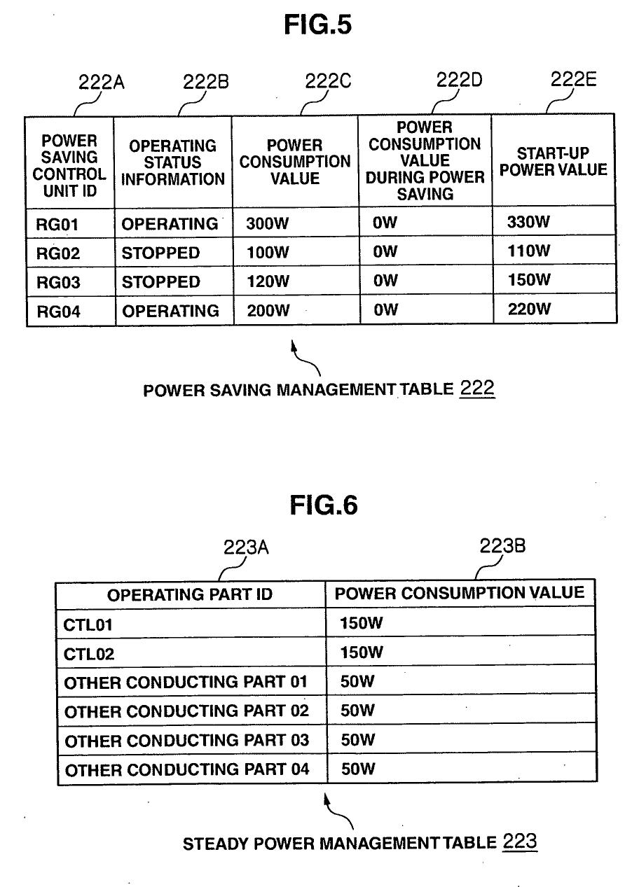

FIG. 6 is a diagram showing an example of the steady power management table 223 stored in the control memory 220 of the basic chassis 400 of the storage apparatus 200.

The steady power management table 223 is used by the power control program 221 to be executed by the CPU 214 in the basic chassis 400 of the storage apparatus 200.

The steady power management table 223 is a table for managing the operating status and power consumption of the parts that are constantly operating and energized. The conducting parts registered in the steady power management table 223 are not subject to power saving control since they are conducting parts that constantly require normal power.

The steady power management table 223 is configured from an “operational part ID” column 223A and a “power consumption value” column 223B.

The “operational part ID” column 223A stores the identifier (for instance the unique identifier of the storage controller 210) of the conducting parts that require constant energization and which are not subject to power saving control among the constituent parts of the storage apparatus 200. The “other conducting parts” stored in the “operational part ID” column 223A are the conducting parts among the constituent components of the storage apparatus 200 that are energized and operate excluding the storage controller 210 such as the fans 230, 260, the power sources 240, 270, a battery (not shown), and a control platform (not shown) of the expanded chassis. The “power consumption value” column 223B stores the power consumption during normal operation for each piece of information stored in the “operational part ID” column 223A.

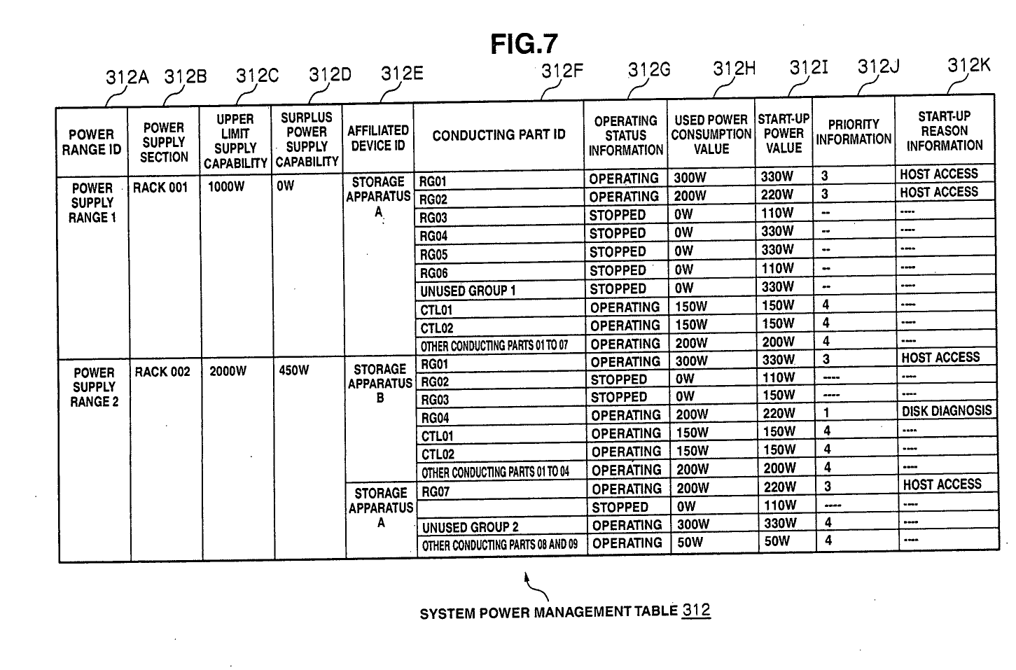

FIG. 7 is a diagram showing an example of the system power management table 312 stored in the memory 310 of the management server 300.

The system power management table 312 is used by the system power management program 311 to be executed by the CPU 321 of the management server 300. The system power management table 312 is a table for uniformly managing the physical arrangement information of the electronic devices (including the storage apparatus 200) connected to the management server 300, information of the power saving control unit of the electronic devices, and information of the power supply range.

The system power management table 312 is configured from a “power range ID” column 312A, a “supply capability section” column 312B, an “upper limit supply capability” column 312C, a “surplus power supply capability” column 312D, an “affiliated appliance ID” column 312E, a “conducting part ID” column 312F, an “operating status information” column 312G, a “power consumption value” column 312H, a “start-up power value” column 3121, a “priority information” column 312J, and a “start-up reason information” column 312K.

The “power range ID” column 312A stores the identifier for individually identifying the power supply range. The “supply capability section” column 312B stores the unique identifier (for instance the unique identifier of the rack) of the physical space included in the power supply range. The “upper limit supply capability” column 312C stores the supply capability upper limit for each power supply range that is set.

The “surplus power supply capability” column 312D stores the value (value registered in the “used power consumption value” column 312H) obtained by deducting the power that is currently being consumed by the electronic devices installed in the power supply range from the supply capability upper limit (value registered in the “upper limit supply capability” column 312C) in a certain power supply range. In other words, the “surplus power supply capability” column 312D stores the surplus power showing how much power is left until reaching the supply capability upper limit of each power supply range.

The “affiliated appliance ID” column 312E stores the unique identifier of the electronic devices installed in the respective power supply ranges. The “conducting part ID” column 312F stores the unique identifier (for instance the unique identifier of the RAID group 251) of the power saving control unit of the electronic devices set in the “affiliated appliance ID” column 312E, or the unique identifier (for instance the unique identifier of the storage controller 210) of the conducting part that is not subject to power saving control among the constituent parts of the electronic devices set in the “affiliated appliance ID” column 312E.

Although the fans 230, 260 are treated as conducting parts in this embodiment, when performing control for suppressing the power consumption by lowering the rotating speed of the fans, the fans 230, 260 may also be stored as power saving control units in the “conducting part ID” column 312F.

The “operating status information” column 312G stores the operating status for each piece of information stored in the “conducting part ID” column 312F. For example, “Starting” is stored if the RAID group 251 is starting and “Stopped” is stored if the RAID group 251 is stopped.

The “used power consumption value” column 312H stores the power consumption that is currently being used by the information stored in the “conducting part ID” column 312F.

The “start-up power value” column 3121 stores the peak power during the start-up for each piece of information stored in the “conducting part ID” column 312F.

The “priority information” column 312J stores the priority information of the plurality of conducting parts in operation to be subject to power saving control or stoppage control. The management server 300 refers to this priority in order to determine whether to perform power saving to or stop of the operating power saving control unit. In this embodiment, priority is set from “1” to “4.” In other words, the conducting part with priority “1” has the highest priority of being subject to power saving control. Contrarily, the conducting part with priority “4” has the lowest priority of being subject to power saving control. Details concerning the information stored in the “priority information” column 312J will be described later.

The “start-up reason information” column 312K stores the reason of start-up when the “operating status information” column 312G of the information stored in the “conducting part ID” column 312F is changed from “Stopped” to “Starting.” Details concerning the information stored in the “start-up reason 312” column K will be described later.

### (1-2) Outline of Operation in First Embodiment

With the information processing system 1 of this embodiment, the storage apparatus 200 reduces the power consumption by starting or stopping the RAID group 251. The RAID group 251 is started and stopped by the power control program 221 to be executed by the CPU 214 in the basic chassis 400. The power control program 221 decides to stop the RAID group 251 when there is no access from the host 100 to the operating RAID group 251 for a given period of time, and contrarily decides to start the RAID group 251 if there is an access from the host 100 to the stopped RAID group 251.

The start and stop of the RAID group 251 is triggered by the status of access from the host 100 in this embodiment, but it may also be triggered by other events. For example, the start and stop of the RAID group 251 may be decided by predicting the access from the host 100 in advance based on a job schedule or the like of a backup server (not shown), or decided based on a command from the management server 300 or another program of the control memory 220 regardless of the status of access from the host 100.

The power supply range is decided in advance upon installing the storage apparatus 200. As shown in the system configuration of this embodiment described above, the power supply range is separated in rack units in this embodiment, and defined with the supply capability upper limit. Moreover, power exceeding the supply capability upper limit will not be supplied. Or, the configuration may be such that power exceeding the supply capability upper limit can be supplied, but the cost for the excess power may be set to be higher than the standard electricity charge.

With the information processing system 1 of this embodiment, as shown with the system configuration of FIG. 3, two storage apparatuses 200A, 200B are arranged. The storage apparatus 200A is arranged across a power supply range (hereinafter referred to as the “power supply range A”) to be supplied with power from the external power source 600A, and a power supply range (hereinafter referred to as the “power supply range B”) to be supplied with power from the external power source 600B. In other words, the basic chassis 400A and certain expanded chassises 410A of the storage apparatus 200A are arranged in the power supply range A, and certain expanded chassises 410A of the storage apparatus 200A as well as the basic chassis 400B and the expanded chassises 410B of the storage apparatus 200B are arranged in the power supply range B. Let it be assumed that the supply capability supply capability upper limit ranges A, B is insufficient for operating all RAID groups 251 of the storage apparatuses 200A, 200B.

### (1-3) Setting Processing of System Power Management Table

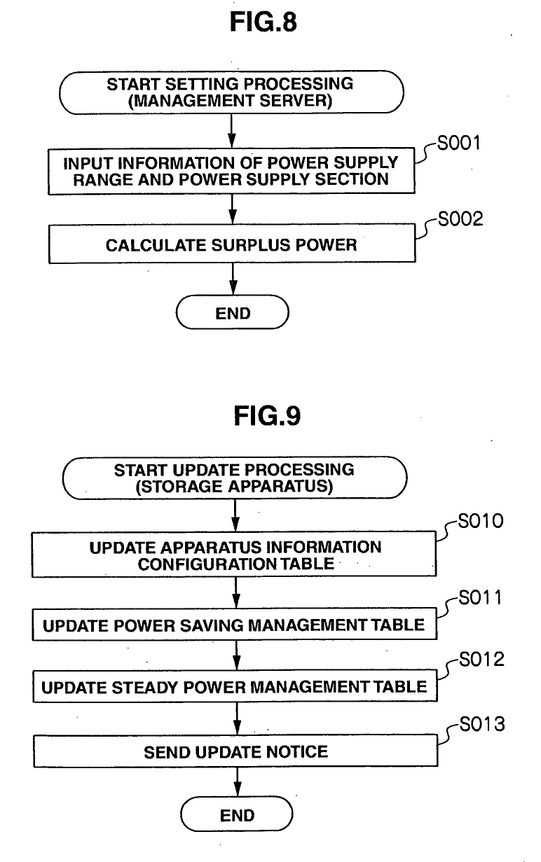

Foremost, FIG. 8 shows an operational example where the CPU 321 of the management server 300 initializes the information concerning the supply capability in the system power management table 312. The setting processing is executed by the CPU 321 based on the system power management program 311.

When a user makes an input via the input unit 322 of the management server 300, the CPU 321 stores the unique identifier of the power supply range in the “power range ID” column 312A, the unique identifier of the physical space contained in the power supply range in the “supply capability section” column 312B, and the supply capability upper limit of this power supply range in the “upper limit supply capability” column 312C (S001).

The management server of the power being distributed to the external power sources 600A, 600B may also collect information such as the power supply range, supply capability upper limit, and unique identifier of the physical space corresponding to the power supply range, and set such information in the system power management table 312. The user may also directly input such information from the input unit 322 of the management server 300. A combination of these methods may also be adopted. This step is implemented during the initial start-up of the management server 300 or when information concerning the supply capability stored in the system power management table 312 is changed as described above. This step may also be implemented by the user at an arbitrary timing. If the collected information is already stored in the system power management table 312 and there is not change to such data, this step may be omitted.

Subsequently, the CPU 321 calculates the surplus energy for each power supply range, and stores the calculated surplus power in the “surplus power supply capability” column 312D (S002). The surplus power is the value obtained by subtracting the used power consumption value from the upper limit supply capability set for each power supply range. This step must be implemented when the value stored in the “used power consumption value” column 312H or the “upper limit supply capability” column 312C of the system power management table 312 is changed.

The foregoing is the operation of the CPU 321 for storing necessary information in the system power management table 312.

### (1-4) Update Processing of System Power Management Table

Since the system power management table 312 needs to constantly manage the latest information, the update processing of the system power management table 312 is now explained. The update processing of the system power management table is executed by the CPU 321 of the management server 300 based on the system power management program 311, and by the CPU 214 of the storage apparatus 200 based on the configuration information management program 224.

### (1-4-1) Storage Apparatus Side

Foremost, in order to update the system power management table 312, it is necessary to collect update information on the side of the storage apparatus 200. The storage apparatus 200-side update processing is now explained.

Specifically, as shown in FIG. 9, foremost, the CPU 214 of the storage apparatus 200 collects the configuration information of the basic chassis 400 and the expanded chassis 410 connected to the basic chassis 400, and updates the apparatus configuration information table 225 (S010).

The apparatus configuration information table 225 stores the physical and logical configuration information of the storage apparatus as described above. When the configuration of the storage apparatus 200 is changed, the changed configuration is reflected in the apparatus configuration information table 225, and the registered information is changed thereby. The timing of changing the apparatus configuration information table 225 may be upon the initial start or restart of the storage apparatus 200, addition or removal of the expanded chassis 410, insertion or removal of the disk device 250, creation or deletion of the RAID group 251 or the logical volume 252, usage of a spare disk, replacement of another conducting part, and so on. These are merely examples and the present invention is not limited thereto. With respect to configuration information that cannot be collected by the CPU 214, the user may manually input such configuration information. The CPU 214 may also collect the information stored in the apparatus configuration information table 225 by coordinating with another storage apparatus 200 or software managing configuration information other than the configuration information management program 224.

Subsequently, the CPU 214 updates the power saving management table 222 based on the operating status of the power saving control unit, and the power consumption values during normal operation, during a power saving status and during start-up of the respective power saving control units (S011).

In accordance with the start or stop of the RAID group 251, the operating status information 222b of the power saving management table 222 is updated to “Operating” or “Stopped.” As the power consumption value, the power consumption value during power saving and the start-up power value of the power saving management table 222, values based on the total value of the power of the disk devices 250 belonging to the respective RAID groups 251 are stored.

In addition, if there is any change in the power consumption of the respective RAID groups 251, the power saving management table 222 is updated. The method of seeking the foregoing power value is calculating based on the power required for the number of disk devices 250 configuring the RAID group 251 upon collecting the configuration information of the storage apparatus 200. The storage apparatus 200 stores information on the power for each disk device 250 in advance.

The method of seeking the foregoing power value may also be based on the power that is actually measured upon the initial operation of the disk device 250 or creation of the RAID group 251 by installing a wattmeter in the storage apparatus 200. Or the user may input such power value. A combination of these methods may also be adopted. The method of seeking the power value of the RAID group 251 is not limited to the foregoing methods. In this embodiment, let it be assumed that the information concerning the power of the disk devices 250 is compiled for each affiliated RAID group 251 and registered in the power saving management table 222.

Further, the CPU 214 uses the power consumption value during operation and start-up of the conducting part that is not subject to power saving control and updates the steady power management table 223 (S012). As the power consumption value of the steady power management table 223, the power consumption during the normal operation of the energized parts other than the power saving control unit (RAID group 251 in this embodiment) is stored. If there is any change in the stored information, the steady power management table 223 is updated. The method of seeking these powers, as with the power saving control unit 222 described above, may be retaining the power of the respective power saving control units in advance, or using the actually measured values or the values input by the user. A combination of these methods may also be adopted. The method of seeking the power of the power saving control unit pertaining to the present invention is not limited to the foregoing methods.

When the update of the apparatus information configuration table, the power saving management table, or the steady power management table is complete, the CPU 214 sends an update notice to the management server 300 (S013), and then ends the update processing.

### (1-4-2) Management Server Side

The update processing of updating the update information collected by the storage apparatus 200 on the side of the management server 300 is now explained.

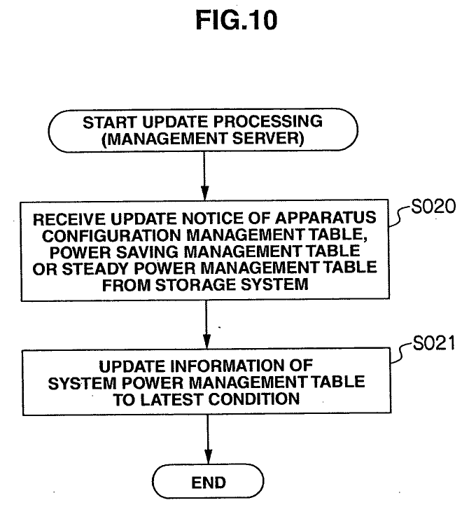

Foremost, as shown in FIG. 10, the CPU 321 of the management server 300 receives an update notice of the apparatus configuration information table 225, the power saving management table 222, or the steady power management table 223 from the storage apparatus 200 (S020). The system power management program 3111 may also constantly monitor the storage apparatus 200 and detect changes.

Subsequently, when the CPU 321 receives information concerning the updated portion of the apparatus configuration information table 225, the power saving management table 222, or the steady power management table 223, it updates the system power management table 312 to the latest status (S021), and then ends the update processing. At step S011, the CPU 321 calculates the surplus power supply capability value once again.

Taking FIG. 7 as an example, the information of the system power management table 213 to be changed at step S021 of FIG. 10 is now explained.

As information to be stored in the system power management table 312 from the apparatus configuration information table 225, for instance, information of the “rack ID” column 225B is stored in the “supply capability section” column 312B, information of the “storage apparatus ID” column 225D is stored in the “affiliated appliance ID” column 312E, and information of the “RAID group ID” column 225F, the “storage controller ID” column 225D, and the “other conducting part” column ID 225E is stored in the “conducting part ID” column 312F.

Subsequently, as information to be stored in the system power management table 312 from the power saving management table 222, for instance, information of the “operating status information” column 222B is stored in the “operating status information” column 312G, information of the “power consumption value” column 222C is stored in the “used power consumption value” column 312H, and information of the “start-up power value” column 222D is stored in the “start-up power value” column 3121, respectively. However, if the information stored in the “operating status information” column 222B is “Stopped” (i.e., the power saving control unit is in a power saving mode), the value to be stored in the “used power consumption value” column 312H will be information of the “power consumption value during power saving” column 222D and not the “power consumption value” column 222C.

Moreover, as information to be stored in the system power management table 312 from the steady power management table 223, for instance, information of the “operational part ID” column 223A coinciding with the “conducting part ID,” information of the “power consumption value” column 223B is stored in the “used power consumption value” column 312H, and the operation status information in the row of the “conducting part ID” column 312F is set to “Operating.”

The priority information” column 312J of the system power management table 312 is information for ranking all conducting part ID belonging to the same power supply range to show the operating priority. In this embodiment, as one example, priority is given with the values of “1” to “4.” A conducting part with priority showing a large numerical value is controlled as a conducting part to be operated with high priority.

For example, if the information stored in the “operational part ID” column 223A and the information stored in the “conducting part ID” column 312F of the steady power management table 223 are the same value, the priority corresponding to the information of the “conducting part ID” column 312F will be assigned “4” showing that it will not be subject to operational control since it needs to be constantly energized.

In addition, if the “operating status information” column 312G is “Stopped,” priority will not be assigned since it is not started with the power saving control unit of the “conducting part ID” column 312F.

If the “operating status information” column 312G is “Starting,” the priority of “1” to “3” is set in the “priority information” column 312J. In this embodiment, the priority of “1” is set if the CPU 214 of the storage apparatus 200 determines that the operational control of the conducting part is necessary. Moreover, the priority of “2” is set if the management server 300 determines that the operational control of the conducting part is necessary. And the priority of “3” is set if operational control is required as a result of the host 100 accessing the conducting part.

The timing of assigning the priority and the setting method thereof will be explained in the operational example of sending a start-up request of the RAID group described later. The foregoing is merely an illustration of this embodiment, and is not intended to limit the present invention.

Further, although priority is not assigned to the conducting part if the operating status information is “Stopped” in the foregoing example, priority may be set by segmentalizing the statuses for each change in power consumption such as “during power saving mode,” “during dormant mode,” or “during stop mode” and so on.

The management server 300 may also collect the configuration information of the energized electronic devices and information concerning the power from the electronic devices other than the storage apparatus 200 connected via the management network or applications managing the configuration information, and set the priority based on such information. The user may also input such information.

If there is an electronic device other than the storage apparatus 200 in the power supply range, the management server 300 may store information concerning this electronic device in the system power management table 312. As an example, if an electronic device is not subject to power saving control and the power source only has the status of ON or OFF, the unique identifier of the rack housing the electronic device is stored in the “supply capability section” column 312b, and the unique identifier of the electronic device is stored in the “affiliated appliance ID” column 312E and the “conducting part ID” column 312F. The ON or OFF status of the power source of the electronic device is stored as “Operating” or “Stopped” in the “operating status information” column 312G.

If the power source of the electronic device is ON, the power consumption during normal operation is stored in the “used power consumption value” column 312H, and if the power source of the electronic device is OFF, the power consumption during stoppage is stored in the “used power consumption value” column 312H. The peak power during operation of the electronic device is stored in the “start-up power value” column 312J. If the electronic device is to be constantly operated, the management server 300 assigns the priority of “4” as the priority information. If the electronic device is stopped, the management server 300 does not assign priority. If the electronic device is subject to power saving control, information of the power saving control unit may be stored in the system power management table 312. If the operating status of the respective electronic devices is changed, the operating status information and power consumption value of the system power management table 312 is also changed accordingly. Update of the operating status of electronic devices may also include a function of the respective electronic devices notifying such update to the management server 300 via the management network 101, or the application managing the configuration information and power of one or more electronic devices may notify the management server 300 via the management LAN 101. In addition, the user may directly register the update from the input unit 322 of the management server 300, and there is no limitation on the method of registering the update. The surplus power supply capability is calculated based on this update, but the details will be described later.

### (1-5) Power Saving Control Processing

The operational routine of the management server and the storage apparatus 200 coordinating to execute power saving control based on the system power management table 312 described above is now explained.

The power saving control processing is executed by the CPU 321 of the management server based on the system power management program 311, and by the CPU 214 of the storage apparatus 200 based on the power control program 221.

### (1-5-1) Outline of Power Saving Control Processing

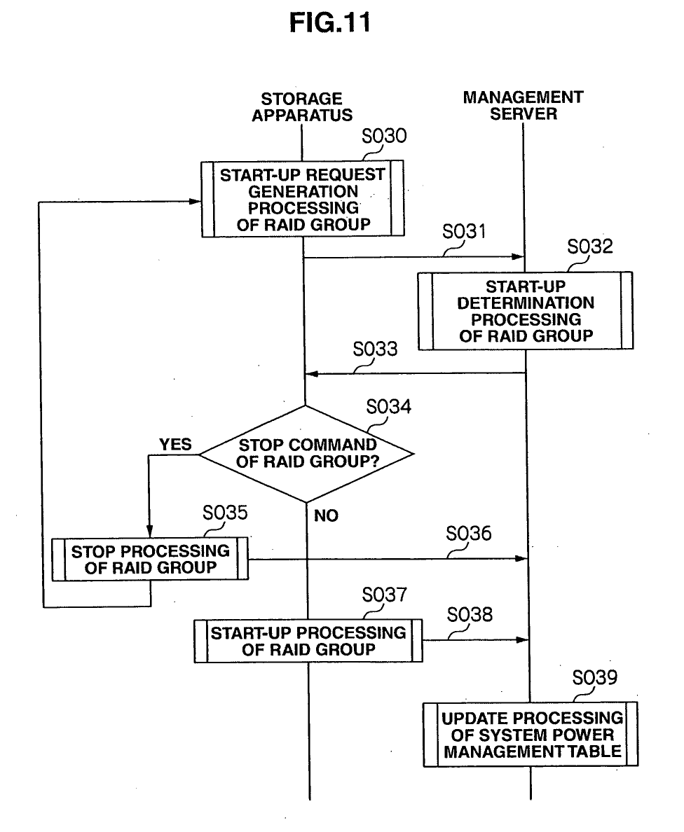

Foremost, as shown in FIG. 11, if a start-up request is issued to a stopped RAID group 251, the CPU 214 executes a start-up request generation processing (S030), and notifies the configuration information of the RAID group 251 as the start-up request target to the management server 300 (S031).

Consequently, the CPU 321 of the management server 300 executes the start-up determination processing (S032), and determines whether the start-up request target RAID group can be started. The CPU 321 of the management server 300 sends a determination command to the storage apparatus 200 (S033).

When the CPU 214 of the storage apparatus 200 receives the determination command from the management server 300, it determines whether that determination command is a start-up command of the start-up request target RAID group or a stop command of the RAID group (S034).

If the determination command is a stop command of the RAID group (S034: YES), the CPU 214 performs the stop processing of the RAID group to be stopped (S035), thereby stops the RAID group that received the stop command, and then sends the result to the management server 300 (S036). Subsequently, the CPU 214 once again executes the start-up request generation processing of the start-up request target RAID group since the surplus power has increased for the amount in which the RAID group was stopped (S030).

Meanwhile, at step S035, if the determination command is a start-up command of the RAID group (S034: NO), the CPU 214 executes the start-up processing to the start-up request target RAID group (S037). The CPU 214 notifies the processing result to the management server 300 (S038).

When the CPU 321 of the management server 300 receives the result at step S036 or step S038, it implements the update processing of the system power management table 312 described above, and updates the information of the system power management table to be the latest information (S039).

The specific processing steps of the RAID group start-up request generation processing (S030), the RAID group start-up determination processing (S032), the RAID group stop processing (S035), the RAID group start-up processing (S037) and the update processing of the system power management table (S039) will be described later.

### (1-5-2) Start-Up Request Generation Processing of RAID Group

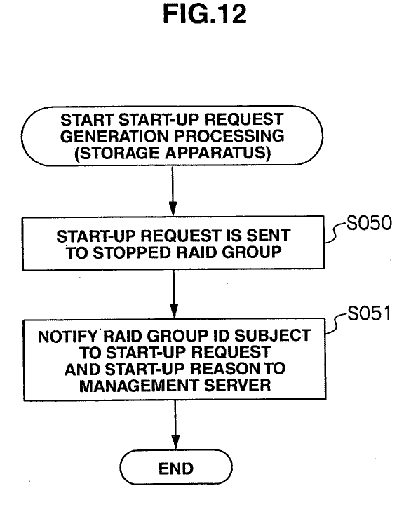

FIG. 12 is a flowchart showing the operational example when a start-up request of the RAID group 251 is generated. The start-up request generation processing corresponds to step S030 of FIG. 11. The processing routine is now explained in sequential steps.

Foremost, the CPU 214 of the storage apparatus 200 starts this processing when it determines that there is a start-up reason for starting an arbitrary RAID group that is currently stopped.

The CPU 214 of the storage apparatus 200 generates a start-up request to an arbitrary RAID group that is stopped (S050).

Since the “operating status information” column 222B is currently “Stopped,” the CPU 214 of the storage apparatus 200 refers to the power saving management table 222, sends the information concerning the start-up request target RAID group and the start-up reason to the management server 300 (S051), and then ends the start-up request generation processing.

The foregoing start-up reason is the information to be ultimately stored by the CPU 321 in the “start-up reason information” column 312K of the system power management table 312, and shows the reason that the RAID group is started. If the information of the “operating status information” column 312G of the RAID group is changed from “Stopped” to “Operating,” it is also information to be used by the CPU 321 for deciding the priority value. As a result of deciding the priority, if the surplus power is insufficient for starting the start-up request RG in the power supply range, the surplus power can be secured by stopping a RAID group (power control unit) in operation having a priority that is lower than the start-up request RG, and thereby secure the power that is necessary to start the start-up request target RAID group.

As an example of this embodiment, the start-up reason of the RAID group 251 is classified into a start-up of the RAID group triggered by a host access such as the reading of data, a start-up of the RAID group triggered by an explicit command from the management server 300, and a start-up of the RAID group to be executed when the storage controller 210 determines that the disk device 250 will enter a predetermined status such as in the diagnosis of the disk device 250 or the start-up of a spare disk.

### (1-5-3) Start-Up Determination Processing of RAID Group

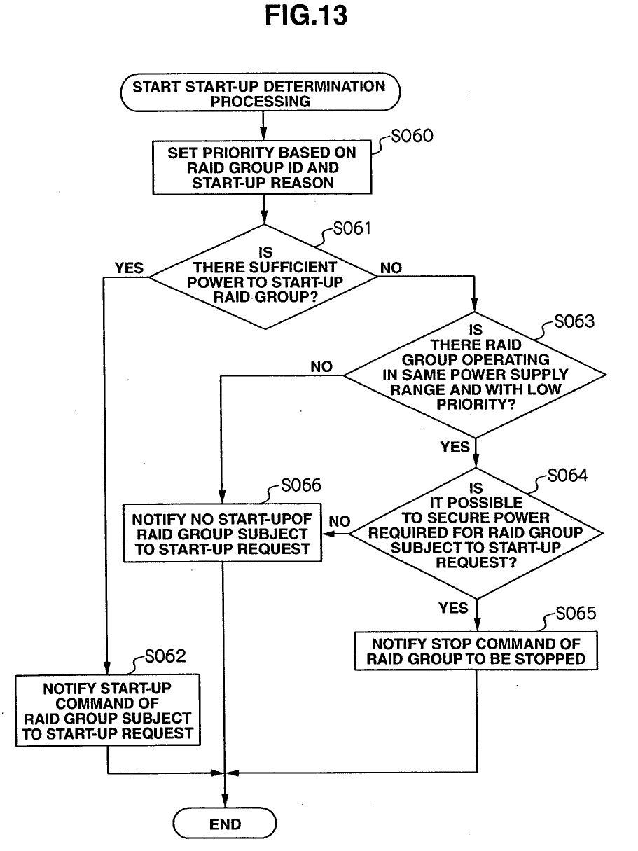

FIG. 13 is a flowchart showing an operational example of the RAID group start-up determination processing to be executed by the CPU 321 of the management server 300 upon receiving a start-up request from the storage apparatus 200. The start-up determination processing corresponds to step S032 of FIG. 11. The processing routine is now explained in sequential steps.

When the CPU 321 of the management server 300 receives a start-up request from the storage apparatus 200, it sets the priority to be registered in the “priority information” column 312J of the system power management table 312 based on the received start-up request target RAID group ID and start-up reason (S060).

If the notified start-up reason is triggered by a host access, the CPU 321 sets the priority of “3.” If the notified start-up reason is triggered by a command from the management server, the CPU 321 sets the priority of “2.” If the notified start-up reason is triggered by the storage controller 210 executing the processing based on its determination, the CPU 321 sets the priority of “1.” The CPU 321 additionally stores the start-up reason received from the storage apparatus 200 in the “start-up reason information” column 312K.

The priority may also be changed at an arbitrary timing in addition to being set when a RAID group start-up request is generated. For example, the user may explicitly change the priority of the “priority information” column 312J at an arbitrary timing, or the management server 300 may set raise the priority of the RAID group (power saving control unit) used by a specific application during a certain period in accordance with the job schedule of the host 100. The management server 300 may also raise the priority only for a specific RAID group. These are merely examples, and other methods may be used.

Subsequently, the CPU 321 of the management server 300 determines whether there is sufficient power required to start the start-up request target RAID group (S061).

The CPU 321 makes this determination by referring to the system power management table 312. Specifically, the CPU 321 compares the start-up power value of the “start-up power value” column 3121 corresponding to the start-up request target RAID group, and the surplus power supply capability value of the “surplus power supply capability” column 312D to which the start-up request target RAID group belongs. If the surplus power supply capability value is greater than the start-up power value, the CPU 321 determines that there is sufficient power required for starting the start-up request target RAID group. Meanwhile, if the surplus power supply capability value is less than the start-up power value, the CPU 321 determines that there is insufficient power required for starting the start-up request target RAID group.

At step S061, if it is determined that there is sufficient power required for starting the start-up request target RAID group (S061: YES), the CPU 321 refers to the system power management table 312 for starting the start-up request target RAID group, sends the start-up request target RAID group ID and the start-up command of the start-up request target RAID group to the storage apparatus 200 (S062), and then ends the start-up determination processing.

Meanwhile, at step S061, if it is determined that there is insufficient power required for starting the start-up request target RAID group (S061: NO), the CPU 321 refers to the system power management table 312, and decides the power supply range to which the start-up request target RAID group belongs. Among the other RAID groups belonging to the decided power supply range, whether there is another RAID group (hereinafter referred to as the “replacement target RAID group”) in which the “operating status information” column 312G shows “Operating” and which is set with priority that is lower than the priority of the start-up request target RAID group (S063).

The priority in this embodiment is set such that smaller the numerical value of priority, the more acceptable it is to stop the operation. Thus, priority that is lower than the priority of the start-up request target RAID group refers to a small priority value. Accordingly, in this case, the CPU 321 searches for another RAID group set to priority “1” in the same power supply range.

At step S063, if there is a replacement target RAID group (S063: YES), the CPU 321 refers to the system power management table 312, and compares the used power consumption value of the replacement target RAID group and the start-up power value of the start-up request target RAID group. If there are a plurality of replacement target RAID groups, the used power consumption value of the replacement target RAID group to be compared may be a total value.

Then, the CPU 321 determines whether power required for starting the start-up request target RAID group can be secured by stopping the operation of the replacement target RAID group (S064).

Since the used power consumption value of the replacement target RAID group is greater than or equal to the start-up power value of the start-up request target RAID group, the CPU 321 determines that it is possible to secure the power required for starting the start-up request target RAID group (S064: YES), sends the replacement target RAID group ID and the stop command to the storage apparatus 200 (S065), and then ends the start-up determination processing. At step S063, if there are a plurality of combinations of one or more replacement target RAID groups having a value that is greater than or equal to the start-up power of the start-up request target RAID group, the CPU 321 sends the RAID group IDs of a combination of the replacement target RAID groups with the lowest priority and the stop command to the storage apparatus 200.

Meanwhile, at step S063, if there is no replacement target RAID group (S063: NO), or the CPU 321 determines that sufficient power required for starting the start-up request target RAID group cannot be secured because the used power consumption value of the replacement target RAID group is of a value that is less than the start-up power value of the start-up request target RAID group at step S064 (S064: NO), it sends a warning to the storage apparatus 200 to the effect that the start-up request target RAID group cannot be started (S066), and then ends the start-up determination processing.

The CPU 321 may also send a warning to the target that triggered the start-up based on the start-up reason corresponding to the start-up request target RAID group. For example, if the RAID group start-up request is generated based on a host access, the CPU 321 notifies the host 100.

The priority information and the start-up reason information stored by the CPU 321 at step S060 are deleted from the system power management table 312, and returned to the status before such information was stored.

When the CPU 321 is to notify the user, it may create a list of the upper limit supply capability value, the surplus power supply capability value, and all conducting part ID belonging to the power range to which the start-up request target RAID group belongs, as well as its operating status information, and the priority information, the start-up reason information, and the used power consumption value of all conducting part IDs, and display such list on the display unit 323 of the management server 300. The information to be displayed is not limited to the above, or information may be information restricted and output.

Among the displayed contents, the user will be able to select the RAID group that needs to be stopped for starting the start-up request target RAID group, increase the upper limit supply capability value in the amount of the power value required for starting the start-up request target RAID group, or delay the start-up of the start-up request target RAID group.

Here, if the user selects the RAID group that needs to be stopped, the CPU 321 notifies the RAID group stop command to the storage apparatus 200, implements the RAID group stop processing described later, implements the update processing of the system power management table 312 (S039), and then executes the start-up determination processing once again.

If the user selects the increase the upper limit supply capability value in the amount of the power value required for starting the start-up request target RAID group, the CPU 321 changes the upper limit supply capability value and the surplus power supply capability value of the system power management table 312, and executes the start-up determination processing once again.

If the user selects to delay the start-up request, the CPU 321 raises a flag (not shown) showing that a failure has occurred in the corresponding start-up request target RAID group of the system power management table 312. The CPU 312 constantly monitors the surplus power supply capability value, and executes the start-up determination processing once again when a surplus power supply capability value corresponding to the start-up power value of the start-up request target RAID group is generated. Without allowing the user to make the selection, the CPU 321 may also automatically delay the start-up of the start-up request target RAID group.

The foregoing was an example of the RAID group start-up determination processing.

### (1-54) Stop Processing of RAID Group

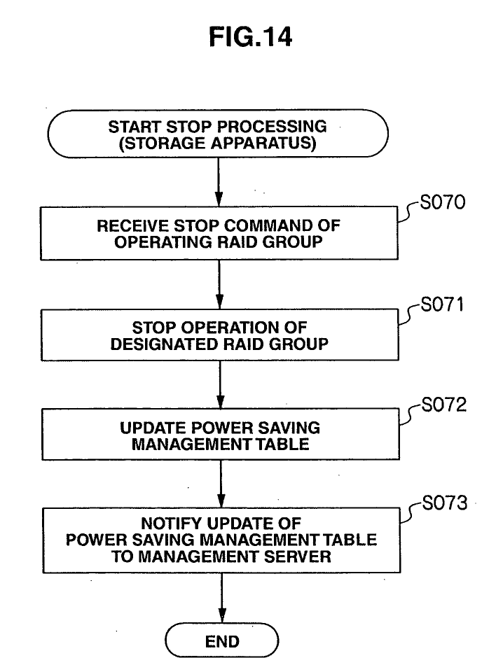

FIG. 14 is a flowchart showing an operational example of the RAID group stop processing to be executed by the CPU 214 of the storage apparatus 200. The stop processing corresponds to step S035 of FIG. 11. The processing routine is now explained in sequential steps.

When the CPU 214 receives a stop command from the management server 300 for stopping an operating RAID group 251 (hereinafter referred to as the “stop request RAID group”), it starts the stop processing (S014). The stop request RAID group to be processed on the side of the storage apparatus 200 is the replacement target RAID group that was processed on the side of the management server 300.

The stop request RAID group includes a RAID group 251 that is not accessed from the host 100 within a predetermined time, a RAID group 251 commanded to be stopped by the management server 300 or the user, and a RAID group 251 designated in the RAID group stop processing. There may be other triggers for executing the RAID group stop processing.

Subsequently, the CPU 214 stops the operation of the RAID group designated by the management server 300. In other words, the CPU 214 stops the operation of the disk devices 250 belonging to the RAID group designated by the management server 300 (S071).

Subsequently, the CPU 214 reflects the stopped RAID group in the power saving management table 222. The information stored in the “operating status information” column 222B of the power saving management table 222 is updated from “Operating” to “Stopped” (S072).

Finally, the CPU 214 notifies the update result of the power saving management table 222 to the management server 300 (S073), and then ends the stop processing.

Subsequently, the CPU 214 returns to step S030, and once again issues a start-up request of the start-up request target RAID group to the management server 300.

The foregoing was an example of the RAID group stop processing according to the present embodiment

### (1-5-5) Start-Up Processing of RAID Group

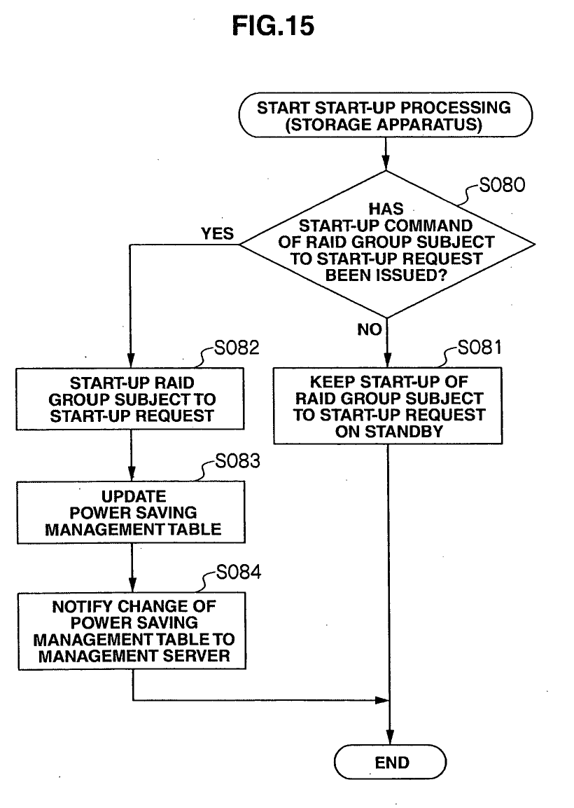

FIG. 15 is a flowchart showing an operational example of the RAID group start-up processing to be executed by the CPU 214 of the storage apparatus 200. The start-up processing corresponds to step S037 of FIG. 11. The processing routine is now explained in sequential steps.

If the CPU 214 of the storage apparatus 200 determines that the command from the management server 300 is not a stop command (S035: NO), it starts the start-up processing.

Subsequently, the CPU 214 determines whether the command from the management server 300 is a start-up command of the start-up request target RAID group (S080).

If the command from the management server 300 is not a start-up command of the start-up request target RAID group (S080: NO), the CPU 214 keeps start-up of the start-up request target RAID group on standby (S081), and then ends the start-up processing.

When keeping the start-up of the start-up request target RAID group on standby at step S081, the CPU 214 may send an error notice or a start-up standby notice to the source of request that triggered the issuance of the start-up request of the start-up request target RAID group in accordance with the start-up reason of the start-up request target RAID group.

Meanwhile, if the command from the management server 300 is a start-up command of the start-up request target RAID group (S080: YES), the CPU 214 starts the disk devices 250 belonging to the start-up request target RAID group (S082).

Subsequently, after the start-up is complete, the CPU 214 updates the operating status information of the power saving management table 222. Specifically, the CPU 214 updates the “operating status information” column 222B corresponding to the RAID group ID that executed the start-up from “Stopped” to Operating” (S083).

The CPU 214 thereafter notifies the update information of the power saving management table 222 to the management server 300 (S084), and then ends the start-up processing.

Upon receiving the notice at step S084, the management server 300 performs the update processing of the system power management table 312.

The foregoing was an example of the RAID group start-up processing according to the present embodiment.

### (1-5-6) Change Processing of Upper Limit of Supply Capability

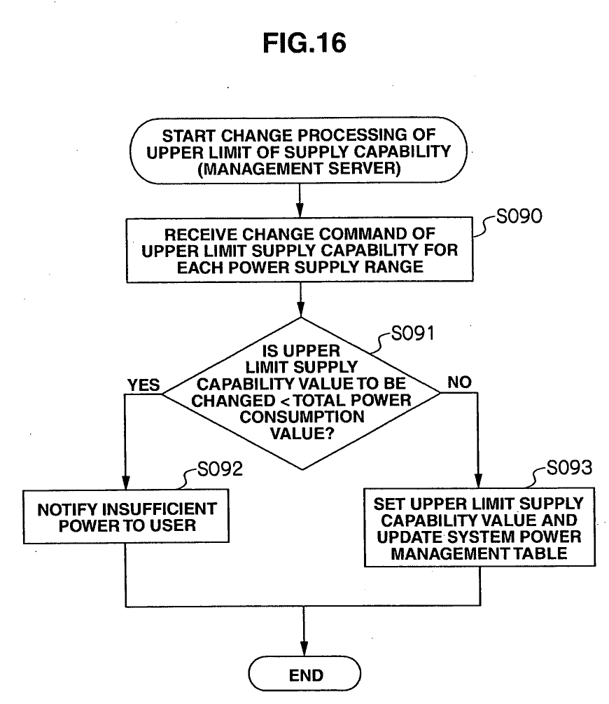

FIG. 16 is a flowchart showing an example of the processing when changing the supply capability supply capability upper limit range. This change processing is executed by the CPU 321 of the management server 300 based on the system power management program 311. The processing routine is now explained in sequential steps.

Foremost, the change processing is started by the CPU 321 of the management server 300 when the user issues a command at an arbitrary timing via the input unit 322 of the management server 300. For example, when changing the upper limit supply capability value of the “upper limit supply capability” column 312C in the system power management table 312 from 1000 W to 500 W, the CPU 321 executes this change processing.

The CPU 321 receives a change command of the supply capability supply capability upper limit range at the foregoing timing (S090). The supply capability supply capability upper limit range to be changed is referred to as an upper limit supply capability value.

Here, normally, the CPU 321 uses the system power management table 312 to constantly monitor, for each power supply range, whether the total value of the power consumption value (hereinafter referred to as the “total amount of power consumption”) of the operating RAID group (conducting part) belonging to this power supply range exceeds the upper limit supply capability value. Thus, if change processing is performed (S090), the CPU 321 determines whether the total amount of power consumption of the operating RAID group for each power supply range is exceeding the upper limit supply capability value scheduled to be changed (S091).

If the total amount of power consumption is exceeding the upper limit supply capability value scheduled to be changed (S091: YES), the CPU 321 notifies the user that, if the upper limit supply capability value is changed, there will be a power shortage in the power supply range (S092), and then ends the change processing.

When the CPU 321 is to notify the user at step S092, it displays a list of the affiliated appliance IDs of the power supply range and the conducting part IDs in operation, a list of the start-up priority or start-up reason and the power consumption of the conducting part ID, and the total amount of power consumption on the display unit 323 of the management server 300. The information to be displayed is not limited to the foregoing information.

The user may select an operating RAID group from the displayed contents so that the total amount of power consumption will be less than the upper limit supply capability value scheduled to be changed, and issue a stop command to the management server 300 for stopping the operation of the selected operating RAID group. In this, the CPU 321 of the management server 300 issues a RAID group stop request to the storage apparatus 200.

Without allowing the user to make a selection, the CPU 321 of the management server 300 may also automatically stop the power saving control unit set with priority that is lower than a predetermined priority threshold value.

If the user determines that there is no RAID group that can be stopped among the operating RAID groups, the CPU 321 of the management server 300 notifies the user that there will be a power shortage in the storage apparatus maintaining the current operating status with the upper limit supply capability value scheduled to be changed. The CPU 321 may also display to the user the shortage of the power value from the difference between the total amount of power consumption and the upper limit supply capability value scheduled to be changed.

At step S091, if the total amount of power consumption is not exceeding the upper limit supply capability value scheduled to be changed (S091: NO), the CPU 321 sets the upper limit supply capability value scheduled to be changed in the “upper limit supply capability” column 312C of the system power management table 312 (S093), and thereafter updates the surplus power value of the “surplus power supply capability” column 312D. The surplus power value is a value that is obtained by subtracting the total amount of power consumption from the upper limit supply capability value after the change.

After the CPU 321 updates the system power management table 312, it ends the change processing. The foregoing was the change processing of the upper limit supply capability value according to the present embodiment.

The foregoing embodiment is merely an example and the present invention is not limited thereto.

In addition, the this embodiment explained a case where the power saving control unit of the storage apparatus 200 is the RAID group 251 configured from one or more disk devices 250, the present invention is not limited to the foregoing configuration. For example, as shown in the conventional technology described above, the power saving control unit may also be a chassis or a fan of the storage apparatus, and it may also be a control platform, a cache memory, a CPU, a power source, or the storage apparatus itself so as long as it is a part that operates by being energized. A combination of these components may also be adopted.

In this embodiment, although the part for storing data from the host 100 is the disk device 250, it may also be a recording device that uses a medium other than the disk device 250. For example, the data storage part may also be a hard disk drive, a semiconductor memory device, a flash memory device, an optical disk drive, an opto-magnetic disk drive, a magnetic tape device, a holographic memory device or the like.

### (1-6) Effect of First Embodiment

According to the present embodiment, the maximum power control of electric devices can be efficiently controlled within the upper limit assigned to the power supply range, and the power usage can be optimized thereby. Consequently, the power consumption can be reduced by starting a conducting part to be subject to power saving control while maintaining the performance thereof.

In addition, according to the present embodiment, the storage apparatus performance and the power saving efficiency can be improved by performing control that gives consideration to the range of the power supplied from an external power source and the physical arrangement of electronic devices including a storage apparatus.

### (2) Second Embodiment

The second embodiment is now explained.

### (2-1) System Configuration of Second Embodiment

Since the configuration of the information processing system 1′ in the second embodiment is the same as the configuration of the information processing system 1 explained in the first embodiment excluding the management server 300, explanation of the same configuration is omitted. The same constituent features as those explained in the first embodiment are given the same reference numeral.

The configuration and functions that are different from the information processing system 1 explained in the first embodiment are now explained.

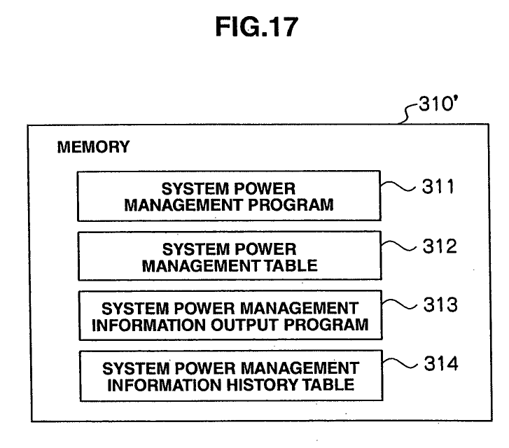

A memory 310′ of a management server 300′ includes, as shown in FIG. 17, in addition to the contents of the memory 310 explained in the first embodiment, a system power management information output program 313 and a system power management information history table 314.

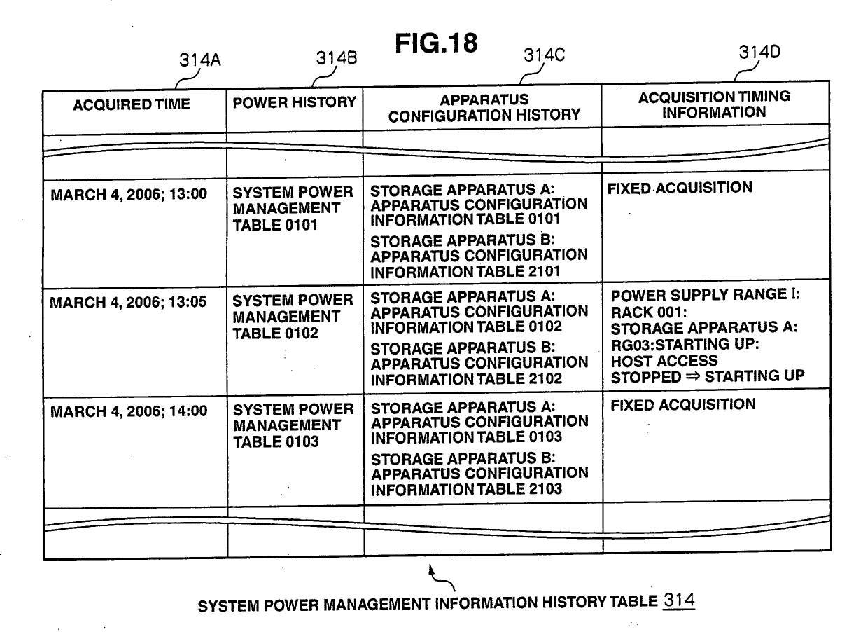

FIG. 18 shows an example of the system power management information history table 314. The system power management information history 314 is a table for recording the history of the relationship of the system power management table 312 and the apparatus configuration information table 225 of all storage apparatuses 200 connected to the management server 300′ for each given timing.

The system power management information history 314 is configured from an “acquired time” column 314A, a “power history” column 314B, an “apparatus configuration history” column 314C, and an “acquisition timing information” column 314D.

The “acquired time” column 314A stores the timing of history. As the specific acquired time, considered may be a time acquired in given intervals, or a time recording the information of the system power management table 314 or the apparatus configuration information table 225 based on the RAID group start-up processing, the RAID group stop processing or the change processing of the upper limit supply capability value.

The “power history” column 314B stores the system power management table 312 recorded at the timing of the acquired time. The “power history” column 314B of FIG. 18 stores the unique identifier showing the system power management table 312 recorded for each acquired time without outputting all information of the system power management table 312. The “power history” column 314B of FIG. 18 stores the pointer to the system power management table 312 to be output.

The “apparatus configuration history” column 314C stores the apparatus configuration information table 225 of each storage apparatus 200 recorded at the timing of the acquired time. The “apparatus configuration history” column 314C of FIG. 18 stores the unique identifier showing the apparatus configuration information table 225 recorded for each acquired time without outputting all information of the apparatus configuration information table 225. The “apparatus configuration history” column 314C of FIG. 18 stores the pointer to the apparatus configuration information table 225 to be output.

The “acquisition timing information” column 314D stores the reason that the power history and the apparatus configuration history were recorded at the timing of the acquired time.

The acquired time stored in the “acquired time” column 314A may be the time that is common to the overall information processing system 1′, or a cumulative value after the information processing system 1′ is operated. Details concerning the acquisition timing of information of the system power management table 312 and the information to be stored in the acquisition timing information 314c will be described later. The present invention is not limited to the foregoing configuration.

### (2-2) Output Processing of Management Screen of System Configuration and Power Usage

Since the processing to be executed by the CPU 321 of the management server 300 in the second embodiment is the same as the processing executed by the CPU 321 in the first embodiment, the explanation thereof is omitted. In addition to the processing executed by the CPU 321 in the first embodiment, the CPU 321 in the second embodiment executes the following output processing of the management screen. The management screen output processing is executed by the CPU 321 based on the system power management information output program 313.

The CPU 321 of the management server 300 uses the latest information of the system power management table 312 and the apparatus configuration information table 225 to output the management screen of the configuration and power usage of the current information processing system 1′ via the display unit 323.

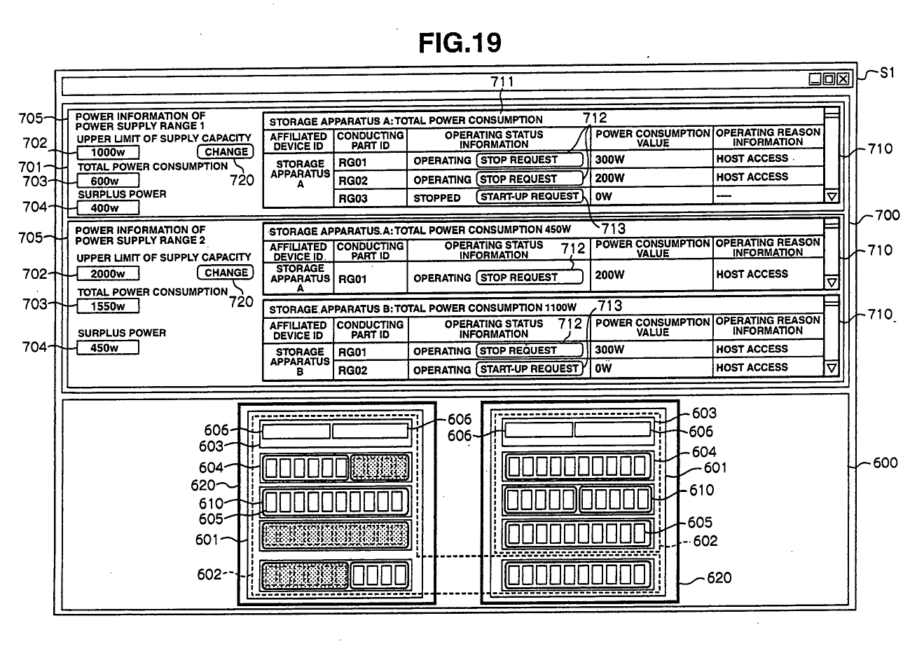

FIG. 19 shows an example of the management screen S1 of the information processing system 1′ displayed on the display unit 322 of the management server 300′ in this embodiment. The management screen S1 of FIG. 19 displays the schematic configuration shown in FIG. 3. As a result of the management server 300′ outputting the management screen S1, the user will be able to comprehend the configuration of electronic devices in addition to the distribution of the supply capability.

Specifically, the lower part 600 of the management screen S1 of FIG. 19 displays, as a schematic diagram, the status of the respective power supply ranges and the physical and logical arrangement of the electronic devices arranged in the power supply range. The arrangement of the physical electronic devices is displayed with a closing line 601 showing the rack as the supply capability section. Electronic devices arranged in the rack are displayed inside the closing line 601 showing the rack. In one example, displayed are a closing line 602 showing the storage apparatuses 200 arranged in the rack, a closing line 603 showing the basic chassis 400 configuring the storage apparatus 200, and a closing line 604 showing the expanded chassises 410. Also displayed are a closing line 605 showing the disk devices 250 built in the respective chassises, and a closing line 606 showing the redundant storage controller 210.

The management screen S1 of FIG. 19 may also display other electronic devices and the other conducting parts of the storage apparatus 200. The relationship included in the displayed parts (i.e., relationship of the rack and the electronic devices arranged in the rack, relationship of the storage apparatus and the basic chassis and the expanded chassises configuring the storage apparatus, etc.) may also be displayed separately by color coding the devices to be arranged internally. The management screen S1 may also display the connection status by displaying the wiring that transmits data and signals.

The management screen S1 displays a closing line 610 showing the RAID group 251 as the logical section of the storage apparatus 200. In addition, the double closing line 620 shows the distribution system of the supply capability, and the closing line 620 encompasses the rack and electronic devices arranged in the power supply range.

In the output example of the management screen shown in FIG. 19, although the electronic devices and data center equipment installed in the same power supply range are encompassed with a closing line, the connecting wire of power feeding system from the external power source can be displayed and encompass the wiring status to the respective electronic devices with a dosing line. Here, the wiring may be color coded for each different supply capability for differentiation.

Subsequently, in this embodiment, the closing line 610 is used to display the RAID group 251 as the power saving control unit of the storage apparatus 200. The closing line 610 improves the visibility and facilitates the comprehension of the operating status by changing the display in accordance with the operating status of the RAID group 251. If the inside of the closing line is displayed with a dark color, this shows that the operating status is “Stopped,” and if the inside of the closing line is displayed with no color, this shows that the operating status is “Operating.” Although not shown, the closing line 605 of the disk devices 250 belonging to the RAID group 251 may also change its color in accordance with the operation or stoppage of the RAID group 251.

Although not shown, if the operation of the other electronic devices or conducting parts is to be started, stopped or subject to power saving control, the display format of the control stages shall be output so that the different stages can be identified through color coding or the like. Here, the difference in the display format may also display an exemplification showing which operating status it is.

Moreover, although not shown in FIG. 19, the unique identifiers of the respective parts shown with the closing lines 601 to 620 may be simultaneously displayed. Further the unique identifier may be displayed in pop-up or the like when the operational mouse cursor is pointed to the respective parts. Although not shown in FIG. 19, the logical volume as the logical section to be formed in the RAID group may also be displayed.

The upper part 700 of the management screen S1 shown in FIG. 19 displays information associated with the conceptual diagram shown in the lower part 600 of the management screen S1. Specifically, the upper part 700 displays, for each power supply range, information corresponding to the power supply range of the system power management table 312 in conjunction with information of the apparatus configuration information table 225. Consequently, the user will be able to manage the operating status of electronic devices and the power of electronic devices by narrowing down the information to information of electronic devices subject to the restriction of the supply capability upper limit in the same power supply range.

As a specific example, in FIG. 19, a section is displayed by being encompassed with a closing line 701 for each power supply range, and displayed in the closing line 701 are a column 702 showing the supply capability upper limit of the power supply range, a column 703 showing the current total power consumption of the power supply range, a column 704 showing the surplus power, and a closing line 705 of the power supply range.

In addition, the upper part 700 displays a change button 720 next to the column 702 showing the supply capability upper limit. When the user presses the button 720, the change processing of the upper limit supply capability explained in the first embodiment is started.

Moreover, displayed in the closing line 701 showing the power supply range is an installed appliance information table 710 for each information stored in the “affiliated appliance ID” column 312E of the power supply range (for each electronic device installed in the power supply range). The installed appliance information table 710 displays the affiliated appliance ID, the conducting part ID, the operating status information, the power consumption value, and the start-up reason information among the items of the system power management table 312. The information to be displayed is not limited to the foregoing information. Here, the conducting part ID may also be displayed by dividing it into the conducting parts in the power saving control unit and the conducting parts to be constantly energized.

Further, the management server 300 may also refer to the apparatus configuration management table 225 and additionally display the configuration information of the storage apparatus 200 that is not stored in the system power management table 312. For example, as the configuration information, the logical volume information, the disk device information, the RAID group redundancy, the disk capacity and so on may be considered. Here, the relationship of the conducting part and the storage apparatus may also be displayed as a table. For instance, all disk devices 250 belonging to the RAID group 251 shown in the installed appliance information table 710 of FIG. 19 may be displayed as shown with the closing line 605. The total value of the power consumption value consumed by all conducting parts configured for each storage apparatus 200 is displayed as the total power consumption 711.

In addition, the upper part 700 displays a RAID group start-up request button 713. When the user presses this button, the RAID group start-up request generation processing shown in the first embodiment is started. The upper part 700 also displays a RAID group stop request button 712. When the user presses this button, the RAID group stop processing shown in the first embodiment is started.

The stop request button 712 and the start-up request button 713 may also not be displayed in accordance with the operational priority set in the first embodiment. For example, if high priority is set since an arbitrary RAID group 251 is constantly operating, the stop request button 712 is not displayed for the operating RAID group 251.

The upper part 700 and the lower part 600 of the management screen S1 are associated and displayed. Specifically, when the user designates arbitrary information of the installed appliance information table 710 in the upper part 700, the lower part 600 emphasizes the display of the designated location by flashing or zooming such designated location. When the user designates an arbitrary location; for instance, the closing line 604 showing the RAID group in the schematic diagram of the lower part 600, the upper part 700 emphasizes the display of corresponding information of the installed appliance information table 710.

The system power management information output program 313 may coordinate with the configuration management software or the like of the storage apparatus 200 to create a RAID group or logical volume in accordance with the power supply range.

For instance, when creating a RAID group across power supply ranges, the user may receive a notice thereof from the management server 300. In FIG. 19, although all power supply ranges were displayed with a single screen, the management screen may also be changed for each power supply range. Instead of sectioning the power supply ranges, the sectioning may be performed in electronic device units and output to the management screen.

### (2-3) Transition of Power Consumption and Output Processing of History

The CPU 321 in the second embodiment executes the following output processing. The output processing is executed by the CPU 321 based on the system power management information output program 313.

The CPU 321 of the management server 300 uses the system power management information history table 314 and displays, using a graph, the respective power supply ranges, transition of the surplus power for each lapse of time in the power supply range, transition of the total power consumption of the power supply range, and total power consumption of each electronic device arranged in the power supply range. The transition of the operating status, power consumption and start-up reason of the conducting part, and the supply capability upper limit if the electronic device is a storage apparatus is displayed.

The CPU 321 of the management server 300 collects information stored in the system power management table 312 and the apparatus configuration management table 225 in predetermined time intervals, and stores the collected information in the system power management information history table 314. The system power management information history table 314 is shown at the lower left part 803 of the management screen S2. The information to be stored has been described above with reference to FIG. 18, and the explanation thereof is omitted.

If the system power management table 312 is changed or the apparatus configuration information management table 225 is changed, the CPU 321 receives a change notice from the management server 300 or the storage apparatus 200. At the timing of receiving this change notice, the CPU 321 once again registered the changed information in the system power management information history table 314. The timing information of acquiring the changed information is registered in the acquisition timing information column, the previously acquired power history information and apparatus configuration history information and the currently stored power history information and apparatus configuration history information are compared, and the information of the system power management table 312 and the apparatus configuration management table 225 subject to change is stored in the acquisition timing information column. The CPU 321 adds a symbol (arrow or the like) showing the change and stores such symbol so that the information before the change and the information after the change can be recognized.

Subsequently, the CPU 321 of the management server 300 uses the collected system power management information history table 314 and outputs the graph showing the transition of the power usage to the display unit 323.

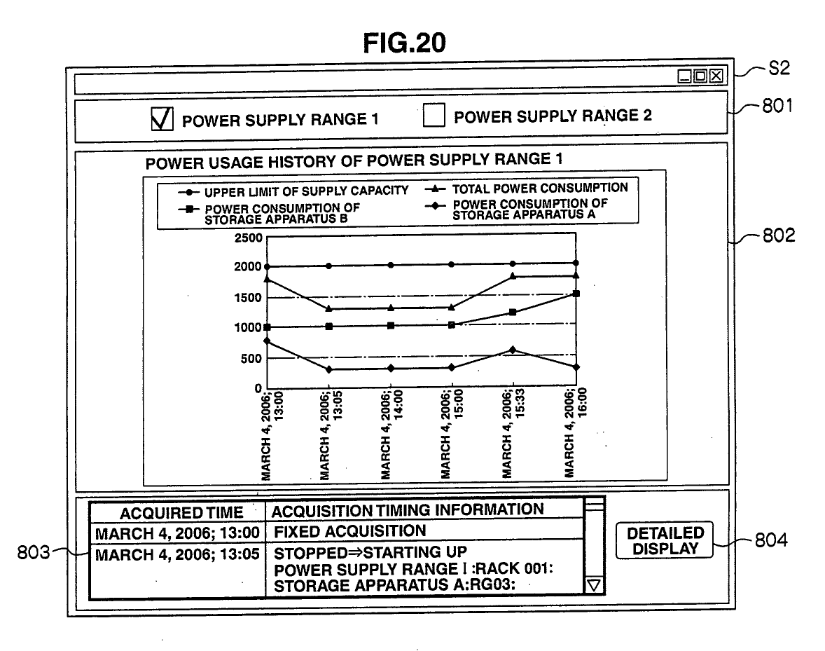

FIG. 20 shows an example of the management screen S2 to be output. The management screen S2 is configured from a selection button unit 801 for switching the information of the power supply range displayed on the graph, a graph display unit 802 showing the power transition of the power supply range selected with the selection button unit 801, a log output unit 803 displaying the acquired time information and the acquisition timing information of the system power management information history table 314, and a detailed display button 804. As a result of the user designating the acquired time of the log output unit 803 and pressing the detailed display button 804, the management screen S2 of the system configuration and power usage of the acquired time designated by the user is displayed. Here, the CPU 321 refers to the power history information and the apparatus configuration information of the system power management information history table 314.

The graph display unit 802 displays a graph where the acquired information is shown in the horizontal axis and the power value is shown in the vertical axis. Output to the graph display unit 802 are, for each acquired time, the upper limit assigned to the power supply range, the power consumption value of the respective storage apparatuses belonging to the power supply range, and the total amount of power consumption of the storage apparatuses belonging to the power supply range.

Although not shown, the CPU 321 may also output and display the power value in which the supply capability upper limit can be changed without reducing the number of operating power saving control units based on the transition of the supply capability upper limit of the power supply range and the total power consumption. The CPU 321 may also use the graph display unit 802 to display the transition of power consumption in power saving control units or conducting part units.

### (2-4) Effect of Second Embodiment

According to the present embodiment, since it is possible to display the power supply range of the system, as well as the physical and logical configuration and the operating status of the arranged electronic devices on the management screen, the operation control with the power saving control unit and changes to the supply capability supply capability upper limit range are facilitated. In addition, the past operating status of electronic devices can be recorded and the past transition can be visually recognized.

Moreover, according to the present embodiment, it is possible to reduce management costs by outputting a management screen based on the physical arrangement of electronic devices including a storage apparatus and the power supply range, and additionally reduce the power consumption while starting a conducting part to be subject to power saving control and maintaining the performance thereof by efficiently controlling the maximum power control of electronic devices within the supply capability upper limit and thereby optimize the power usage.

Moreover, according to the present embodiment, it is possible to improve the storage apparatus performance and power saving efficiency by performing control that gives consideration to the range of power that is supplied from an external power source and the physical arrangement of electronic devices including a storage apparatus

What is claimed is:

1. A management apparatus connected to a storage apparatus arranged in a power supply range set with a threshold value of power supplied externally, comprising:
a control unit configured to control, based on the power threshold value and electric energy used for operating one or more conducting parts that are energized through supply of external power and subject to power saving control, the power supplied to the one or more conducting parts in conducting part units.

2. The management apparatus according to claim 1, further comprising:
a calculation unit configured to calculate surplus electric energy available in the supply capacity range set with the power threshold value based on the power threshold value and the electric energy used for operating the one or more conducting parts; and
a determination unit configured to compare, based on a start-up request of an arbitrary conducting part from the storage apparatus, surplus electric energy required for starting up the arbitrary conducting part and the calculated surplus electric energy, and determining the status of start-up.

3. The management apparatus according to claim 2, further comprising:
a setting unit configured to set priority in the one or more conducting parts to be subject to power saving control; and
a first issue unit configured to issue a command to the storage apparatus for subjecting the one or more conducting parts operating in the power supply range in the order of priority to power saving control when the determination unit determines that surplus power for starting up the arbitrary conducting part is unavailable.

4. The management apparatus according to claim 2, further comprising:
a management unit configured to manage, as management information, the electric energy used for operating the one or more conducting parts, the power threshold value, and the surplus electric energy available in the power supply range set with the power threshold value based on the power threshold value and the electric energy used for operating the one or more conducting parts; and
an output unit configured to output the management information and a physical arrangement where the one or more conducting parts are arranged in the power supply range to a management screen.

5. The management apparatus according to claim. 2,
wherein the control unit controls the start-up and stoppage in RAID units.

6. A storage apparatus connected to a management apparatus and arranged in a power supply range set with a threshold value of power supplied externally, comprising:
one or more conducting parts that are energized through supply of external power and subject to power saving control; and
a control unit configured to control the power supplied to the one or more conducting parts in conducting part units based on the power threshold value and the electric energy used for operating the one or more conducting parts according to a command from the management apparatus.

7. The storage apparatus according to claim 6, further comprising:
a second issue unit configured to issue, a start-up request of an arbitrary conducting part;
a stop unit configured to stop, upon receiving a command from the management apparatus for stopping the operation of a designated conducting part among the one or more conducting parts, the operation of the designated conducting part; and
a third issue unit configured to re-issue a start-up request of the arbitrary conducting part after the designated conducting part is stopped with the stop unit.

8. An information processing system comprising a management apparatus and a storage apparatus connected to the management apparatus,
wherein the storage apparatus is arranged in a power supply range set with a threshold value of power supplied externally, and includes one or more conducting parts that are energized through supply of external power and subject to power saving control; and
wherein the management apparatus includes a control unit configured to control, based on the power threshold value and electric energy used for operating one or more conducting parts, the power supplied to the one or more conducting parts in conducting part units.

9. The information processing system according to claim 8,
wherein the management apparatus includes:
a calculation unit configured to caluculate, surplus electric energy available in the supply capacity range set with the power threshold value based on the power threshold value and the electric energy used for operating the one or more conducting parts; and
a determination unit configured to compare, based on a start-up request of an arbitrary conducting part from the storage apparatus, surplus electric energy required for starting up the arbitrary conducting part and the calculated surplus electric energy, and determining the status of start-up.

10. The information processing system according to claim 9,
wherein the management apparatus includes:
a setting unit configured to set, priority in the one or more conducting parts to be subject to power saving control; and
a first issue unit configured to issue, a command to the storage apparatus for subjecting the one or more conducting parts operating in the power supply range in the order of priority to power saving control when the determination unit determines that surplus power for starting up the arbitrary conducting part is unavailable.

11. The information processing system according to claim 9,
wherein the management apparatus includes:
a management unit configured to manage, as management information, the electric energy used for operating the one or more conducting parts, the power threshold value, and the surplus electric energy available in the power supply range set with the power threshold value based on the power threshold value and the electric energy used for operating the one or more conducting parts; and
an output unit configured to output, the management information and a physical arrangement where the one or more conducting parts are arranged in the power supply range to a management screen.

12. The information processing system according to claim 9,
wherein the storage apparatus includes:
a second issue unit configured to issue, a start-up request of an arbitrary conducting part;
a stop unit configured to stop, upon receiving a command from the management apparatus for stopping the operation of a designated conducting part among the one or more conducting parts, the operation of the designated conducting part; and
a third issue unit configured to re-issue, a start-up request of the arbitrary conducting part after the designated conducting part is stopped with the stop unit.

13. The information processing system according to claim 9,
wherein the control unit controls the start-up and stoppage in RAID units.
